(19) United States
(12) Patent Application Publication
(10) Pub. No.: US 2026/0112012 A1
(43) Pub. Date: Apr. 23, 2026

(54) IMAGING TEST CHART, INFORMATION PROCESSING APPARATUS, AND INFORMATION PROCESSING METHOD

(71) Applicant: NEC Corporation, Minato-ku, Tokyo (JP)

(72) Inventor: Yuka OGINO, Tokyo (JP)

(73) Assignee: NEC Corporation, Minato-ku, Tokyo (JP)

(21) Appl. No.: 19/116,439

(22) PCT Filed: Oct. 14, 2022
(86) PCT No.: PCT/JP2022/038455

§ 371 Date: Mar. 28, 2025

(51) Int. Cl. G06T 7/00

(52) U.S. Cl. CPC G06T 7/00

(57) ABSTRACT

An imaging test chart (100) includes an iris pattern IRP for evaluating at least one of an imaging environment and an imaging setting.

### TECHNICAL FIELD

This disclosure relates to an imaging test chart, an information processing apparatus, an information processing method, and a medium.

### BACKGROUND ART

Various imaging test charts used for acquiring an excellent image in which a subject is imaged from an imaging apparatus such as a camera are proposed. For example, Patent Document 1 describes that an imaging environment characteristic evaluation chart for measuring a characteristic of incident light from a light source being applied to a subject as an evaluation target is used.

### RELATED DOCUMENT

### Patent Document

Patent Document 1: Japanese Patent Application Publication No. 2021-043722

### SUMMARY

### Technical Problem

This disclosure has an object to improve the technique described in the related document described above.

### Solution to Problem

One aspect of the present invention provides an imaging test chart including an iris pattern for evaluating at least one of an imaging environment and an imaging setting.

One aspect of the present invention provides an information processing apparatus including
creating a chart image including an iris pattern for evaluating at least one of an imaging environment and an imaging setting.

One aspect of the present invention provides an information processing method including,
by one or more computers,
creating a chart image including an iris pattern for evaluating at least one of an imaging environment and an imaging setting.

One aspect of the present invention provides a medium that stores a program for causing one or more computers to execute
creating a chart image including an iris pattern for evaluating at least one of an imaging environment and an imaging setting.

One aspect of the present invention provides an information processing apparatus including:
a chart image acquisition unit that acquires a chart image including an iris pattern for evaluating at least one of an imaging environment and an imaging setting; and
a display control unit that causes a display unit to display the chart image.

One aspect of the present invention provides an information processing method including,
by one or more computers:
acquiring a chart image including an iris pattern for evaluating at least one of an imaging environment and an imaging setting; and
causing a display unit to display the chart image.

One aspect of the present invention provides a medium that stores a program for causing one or more computers to execute:
acquiring a chart image including an iris pattern for evaluating at least one of an imaging environment and an imaging setting; and
causing a display unit to display the chart image.

One aspect of the present invention provides an information processing apparatus including:
an imaging image acquisition unit that acquires a chart imaging image being an image in which an imaging test chart or a chart image including an iris pattern for evaluating at least one of an imaging environment and an imaging setting is imaged;
a registration data acquisition unit that acquires registration data including an iris pattern included in the imaging test chart or the chart image;
a detection unit that detects an iris pattern from the acquired chart imaging image;
a verification unit that verifies the detected iris pattern with an iris pattern included in the registration data;
a score acquisition unit that obtains an evaluation score for evaluating at least one of the iris pattern and the chart imaging image, based on a result of at least one of the detection and the verification; and
an output control unit that causes an output unit to output a value based on the evaluation score.

One aspect of the present invention provides an information processing method including,
by one or more computers:
acquiring a chart imaging image being an image in which an imaging test chart or a chart image including an iris pattern for evaluating at least one of an imaging environment and an imaging setting is imaged;
acquiring registration data including an iris pattern included in the imaging test chart or a chart image;
detecting an iris pattern from the acquired chart imaging image;
verifying the detected iris pattern with an iris pattern included in the registration data;
obtaining an evaluation score for evaluating at least one of the iris pattern and the chart image, based on a result of at least one of the detection and the verification; and
causing an output unit to output the evaluation score.

One aspect of the present invention provides a medium that stores a program for causing one or more computer to execute:
acquiring a chart imaging image being an image in which an imaging test chart or a chart image including an iris pattern for evaluating at least one of an imaging environment and an imaging setting is imaged;
acquiring registration data including an iris pattern included in the imaging test chart or the chart image;
detecting an iris pattern from the acquired chart imaging image;
verifying the detected iris pattern with an iris pattern included in the registration data;
obtaining an evaluation score for evaluating at least one of the iris pattern and the chart image, based on a result of at least one of the detection and the verification; and
causing an output unit to output the evaluation score.

### BRIEF DESCRIPTION OF THE DRAWINGS

FIG. 1 is a diagram illustrating an overview of an imaging test chart according to an example embodiment 1.

FIG. 2 is a diagram illustrating an overview of an information processing apparatus according to the example embodiment 1.

FIG. 3 is a flowchart illustrating an overview of an information processing method according to the example embodiment 1.

FIG. 4 is a diagram illustrating an overview of an information processing apparatus according to the example embodiment 1.

FIG. 5 is a flowchart illustrating an overview of an information processing method according to the example embodiment 1.

FIG. 6 is a diagram illustrating an example of the imaging test chart according to the example embodiment 1.

FIG. 7 is a diagram illustrating a configuration example of a black eye image according to the example embodiment 1.

FIG. 8 is a diagram illustrating a configuration example of an information processing system according to the example embodiment 1.

FIG. 9 is a diagram illustrating a functional configuration example of a chart creation apparatus according to the example embodiment 1.

FIG. 10 is a diagram illustrating a functional configuration example of an evaluation apparatus according to the example embodiment 1.

FIG. 11 is a diagram illustrating a physical configuration example of the chart creation apparatus according to the example embodiment 1.

FIG. 12 is a flowchart illustrating an example of chart creation processing according to the example embodiment 1.

FIG. 13 is a diagram illustrating one example of a rectangular pattern according to the example embodiment 1.

FIG. 14 is a diagram illustrating one example of an iris pattern IRP according to the example embodiment 1.

FIG. 15 is a flowchart illustrating an example of evaluation processing according to the example embodiment 1.

FIG. 16 is a diagram illustrating a first display example of an evaluation score according to the example embodiment 1.

FIG. 17 is a diagram illustrating a second display example of an evaluation score according to the example embodiment 1.

FIG. 18 is a diagram illustrating a configuration example of an information processing system according to an example embodiment 2.

FIG. 19 is a diagram illustrating a functional configuration example of a chart display apparatus according to the example embodiment 2.

FIG. 20 is a flowchart illustrating one example of chart display processing according to the example embodiment 2.

FIG. 21 is a diagram illustrating an example of a specific test chart according to an example embodiment 3.

FIG. 22 is a diagram illustrating a functional configuration example of an output control unit according to an example embodiment 5.

FIG. 23 is a flowchart illustrating an example of evaluation processing according to the example embodiment 1.

FIG. 24 is a diagram illustrating a functional configuration example of an evaluation apparatus according to an example embodiment 6.

FIG. 25 is a flowchart illustrating an example of environment adjustment processing according to the example embodiment 6.

### EXAMPLE EMBODIMENT

Hereinafter, one example embodiment of the present invention will be described by using drawings. Note that, in all of the drawings, a similar component has a similar reference sign, and description thereof will be appropriately omitted.

### Example Embodiment 1

### Overview

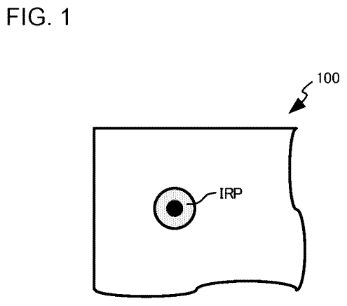

FIG. 1 is a diagram illustrating an overview of an imaging test chart 100 according to an example embodiment 1. The imaging test chart 100 includes an iris pattern IRP for evaluating at least one of an imaging environment and an imaging setting.

With the imaging test chart 100, an image suitable for iris recognition can be easily acquired.

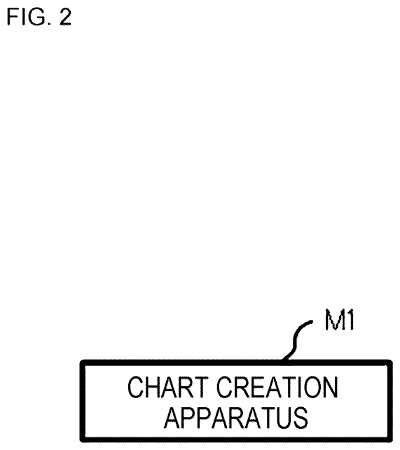

FIG. 2 is a diagram illustrating an overview of an information processing apparatus (corresponding to a “chart creation apparatus” described below) M1 according to the example embodiment 1. The information processing apparatus M1 creates a chart image including the iris pattern IRP for evaluating at least one of an imaging environment and an imaging setting.

With the information processing apparatus M1, an image suitable for the iris recognition can be easily acquired.

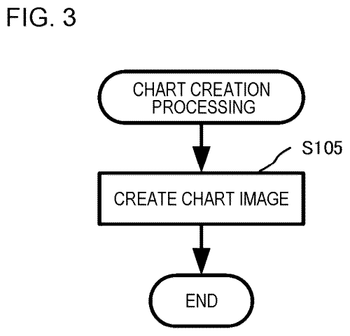

FIG. 3 is a flowchart illustrating an overview of an information processing method (corresponding to “chart creation processing” described below) according to the example embodiment 1. The information processing apparatus MI creates a chart image including the iris pattern IRP for evaluating at least one of an imaging environment and an imaging setting.

With the information processing method, an image suitable for the iris recognition can be easily acquired.

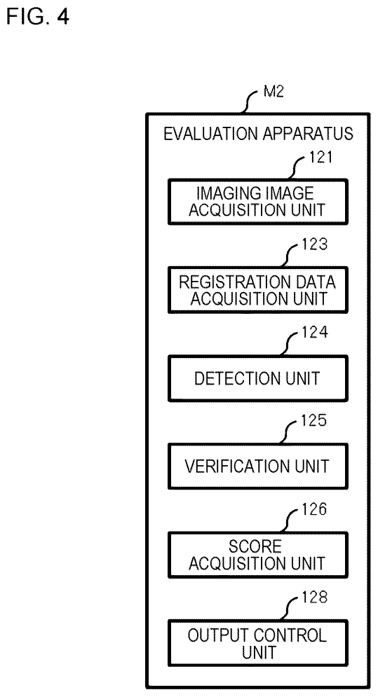

FIG. 4 is a diagram illustrating an overview of an information processing apparatus (corresponding to an “evaluation apparatus” described below) M2 according to the example embodiment 1. The information processing apparatus M2 includes an imaging image acquisition unit 121, a registration data acquisition unit 123, a detection unit 124, a verification unit 125, a score acquisition unit 126, and an output control unit 128.

The imaging image acquisition unit 121 acquires a chart imaging image being an image in which an imaging test chart or a chart image including the iris pattern IRP for evaluating at least one of an imaging environment and an imaging setting is imaged.

The registration data acquisition unit 123 acquires registration data including the iris pattern IRP included in the imaging test chart or the chart image.

The detection unit 124 detects the iris pattern IRP from the acquired chart imaging image.

The verification unit 125 verifies the detected iris pattern with the iris pattern IRP included in the registration data.

The score acquisition unit 126 obtains an evaluation score for evaluating at least one of the iris pattern IRP and the chart imaging image, based on a result of at least one of the detection and the verification.

The output control unit 128 causes an output unit to output a value based on the evaluation score.

With the information processing apparatus M2, an image suitable for the iris recognition can be easily acquired.

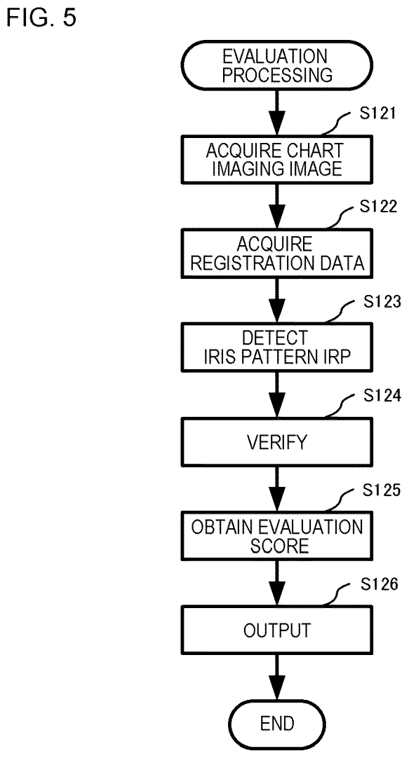

FIG. 5 is a flowchart illustrating an overview of an information processing method (corresponding to “evaluation processing” described below) according to the example embodiment 1.

The imaging image acquisition unit 121 acquires a chart imaging image being an image in which an imaging test chart or a chart image including the iris pattern IRP for evaluating at least one of an imaging environment and an imaging setting is imaged (step S121).

The registration data acquisition unit 123 acquires registration data including the iris pattern IRP included in the imaging test chart or the chart image (step S122).

The detection unit 124 detects the iris pattern IRP from the acquired chart imaging image (step S123).

The verification unit 125 verifies the detected iris pattern with the iris pattern IRP included in the registration data (step S124).

The score acquisition unit 126 obtains an evaluation score for evaluating at least one of the iris pattern IRP and the chart imaging image, based on a result of at least one of the detection and the verification (step S125).

The output control unit 128 causes the output unit to output a value based on the evaluation score (step S126).

With the information processing method, an image suitable for the iris recognition can be easily acquired.

A detailed example of the imaging test chart 100 and the like according to the example embodiment 1 will be described below.

### (Detail)

In general, in order to acquire an iris image suitable for the iris recognition, at least one of an imaging environment and an imaging setting is often adjusted in the iris recognition. The iris image is an image in which an iris is captured. The imaging setting is a setting applied to imaging for the iris recognition.

However, the imaging environment characteristic evaluation chart described in Patent Document 1 is used for general imaging. Thus, even in a case where the imaging environment characteristic evaluation chart described in Patent Document 1 is used for imaging for the iris recognition, it is difficult to appropriately adjust at least one of an imaging environment and an imaging setting, and an image suitable for the iris recognition may be difficult to acquire.

One example of an object of this disclosure is, in view of the problem described above, to provide an imaging test chart, an information processing apparatus, an information processing method, a medium, and the like that solve the problem to easily acquire an image suitable for the iris recognition.

(Configuration Example of Imaging Test Chart 100 according to Example Embodiment 1)

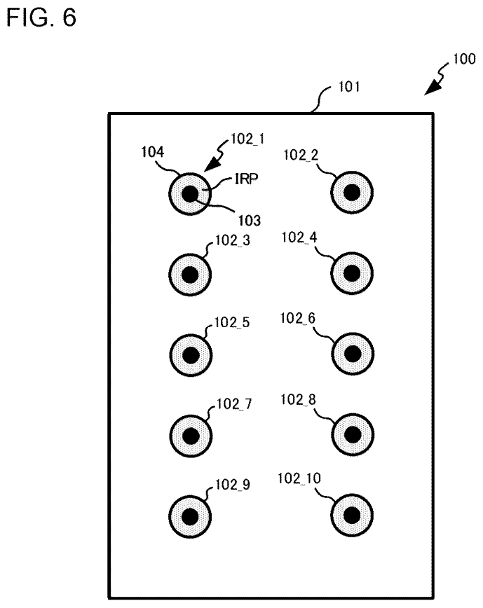

FIG. 6 is a diagram illustrating an example of the imaging test chart 100 according to the example embodiment 1.

The imaging test chart 100 is a chart for evaluating at least one of an imaging environment and an imaging setting.

The imaging environment herein is, for example, an environment in which imaging for the iris recognition is performed. As one example of the imaging environment, an irradiation environment of light in an imaging place for the iris recognition can be cited. The light may be various types of light, and is, for example, light from a window, light from the sun, light irradiated for imaging such as strobe light, and the like.

Further, the imaging setting is a setting applied to imaging for the iris recognition. The imaging setting may include, for example, one or more of a modulation transfer function (MTF), contrast, a brightness value, setting related to an imaging range of an imaging apparatus and the like, and the like. The setting related to an imaging range of an imaging apparatus is, for example, at least one of an angle indicating an imaging direction by panning and tilting, imaging magnification by zooming, and the like in a case where the imaging apparatus has a function such as panning, tilting, and zooming.

The imaging test chart 100 includes a sheet 101, and ten black eye images 102_1 to 102_10 provided on the sheet 101.

Hereinafter, the “imaging test chart 100″ is also expressed as the ”test chart 100″.

Further, in a case where the black eye images 102_1 to 102_10 are not particularly distinguished, the black eye images 102_1 to 102_10 are also expressed as the “black eye image 102”.

Note that, the number of the black eye images 102 included in the test chart 100 is not limited to ten, and may be one or more.

The sheet 101 is, for example, a rectangular sheet with a width of about 100 to 200 mm (millimeters) and a length of about 100 to 300 mm.

The sheet 101 is desirably not transparent, and a material thereof is, for example, cardboard, plastic, wood, metal, glass, or a combination of one or a plurality thereof. In a case where a material of the sheet 101 is cardboard, plastic, wood, and the like, the sheet 101 is lightweight, and carrying of the sheet 101 can be facilitated. Note that, a shape, dimensions, and a material of the sheet 101 are not limited to those described herein, and may be appropriately changed.

Each of the black eye images 102 is a region with a pattern imitating a black eye. The black eye according to the present example embodiment is a black eye of a person. Note that, the black eye may not be a person's and may be an animal's.

The plurality of black eye images 102 are provided in positions different from each other on the sheet 101. A method for providing the black eye image 102 on the sheet 101 may be an appropriate method such as, for example, printing, sticking of a printed matter, and sticking of a sticker.

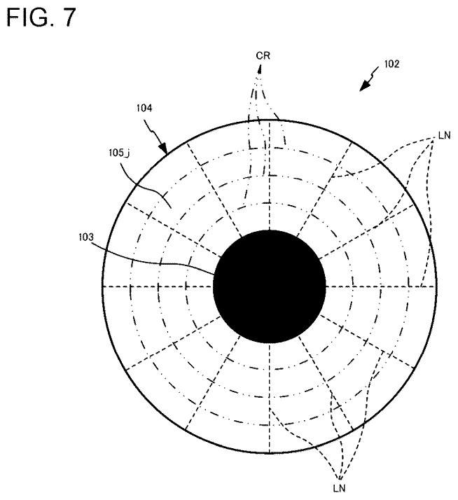

FIG. 7 is a diagram illustrating a configuration example of the black eye image 102 according to the example embodiment 1.

The black eye image 102 is formed of a pupil region 103 and an iris region 104.

Herein, “formed of” does not intend to exclude a fact that the black eye image 102 further includes an element other than the pupil region 103 and the iris region 104.

The pupil region 103 is a region imitating a pupil, i.e., a region associated with a pupil. The pupil region 103 according to the present example embodiment is a substantially circular region filled in with black.

The iris region 104 is a region imitating an iris, i.e., a region associated with an iris. The iris region 104 according to the present example embodiment is an annular band-shaped region that is circumscribed on the pupil region 103 and concentric with the pupil region 103.

Herein, the “annular band-shaped region” is a ring-shaped region with a width, i.e., a region surrounded by concentric circles with radii different from each other. A “band annular shape”is a shape formed by a band annular region.

An outer diameter of the iris region 104 may be equal to, for example, an outer diameter of an iris of an actual person or an average of the outer diameters. An outer diameter of the iris region 104 may be, for example, 10 millimeters to 12 millimeters. Note that, an outer diameter of the iris region 104 is not limited thereto, and may be appropriately changed.

The iris region 104 is provided with the iris pattern IRP.

The iris pattern IRP is a pattern in which brightness is different from each other in at least a part of a plurality of small regions 105_j acquired by dividing the iris region 104. Herein, j is an integer from 1 to N. N is an integer equal to or more than 2.

The plurality of small regions 105_j are regions acquired by dividing the iris region 104 by one or a plurality of circles CR that are concentric with the pupil region 103 and one or a plurality of straight lines LN passing through the center of the pupil region 103. In this way, each of the plurality of small regions 105_j has a circular arc shape with a width.

For example, the one or the plurality of circles CR dividing the iris region 104 may divide between an outer edge of the pupil region 103 (i.e., an inner edge of the iris region 104) and an outer edge of the iris region 104 at a regular interval in a diameter direction. Further, in a case where the straight lines LN dividing the iris region 104 are plural, an angle formed between the straight lines LN adjacent to each other may all be equal.

FIG. 7 illustrates an example in which the circles CR are three and the straight lines In are six. As a result, an example in which the iris region 104 is divided into 48 small regions 105_1 to 105_48 with shapes similar to one another is indicated.

Note that, a shape, a size, and the like of the small region 105 j described herein are one example, and may be appropriately changed, and, for example, shapes may not be similar to one another.

Brightness of the plurality of small regions 105_j may have, for example, two gray levels of white and black. Note that, brightness of the plurality of small regions 105_j may have, for example, three or more gray levels or may be in color.

The iris patterns IRP included in the plurality of black eye images 102 are different from each other.

There are various manners of the iris patterns IRP different from each other.

For example, in a case where the iris patterns IRP are different from each other, resolutions of the iris patterns IRP may be different. A resolution of the iris pattern IRP is an index such as a value representing roughness of the iris pattern IRP, and is associated with the number of the small regions 105_j acquired by dividing the iris region 104 provided with the iris pattern IRP. In other words, in the case where the iris patterns IRP are different from each other, the number of the small regions 105_j acquired by dividing the iris region 104 provided with the iris pattern IRP may be different.

For example, in the case where the iris patterns IRP are different from each other, resolutions of the iris patterns IRP may be the same. In a case where brightness of at least one of the small regions 105_j associated with a position is different in the iris region 104 provided with the iris pattern IRP, the iris patterns IRP are different from each other.

(Configuration Example of Information Processing System 110 according to Example Embodiment 1)

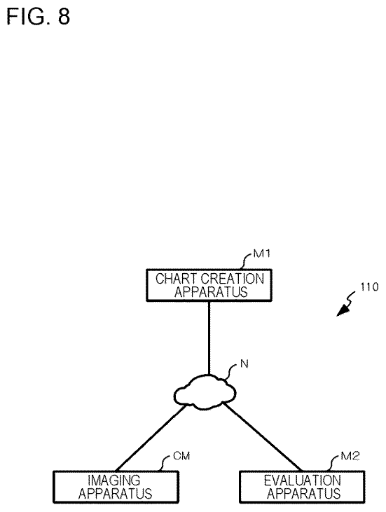

FIG. 8 is a diagram illustrating a configuration example of an information processing system 110 according to the example embodiment 1. The information processing system 110 includes the chart creation apparatus M1, an imaging apparatus CM, and the evaluation apparatus M2.

The chart creation apparatus M1, the imaging apparatus CM, and the evaluation apparatus M2 are connected to one another in such a way as to be able to transmit and receive information to and from one another via a network N. The network N is, for example, a communication network constituted in a wired manner, a wireless manner, or a combination of the manners.

(Functional Configuration Example of Chart Creation Apparatus M1 according to Example Embodiment 1)

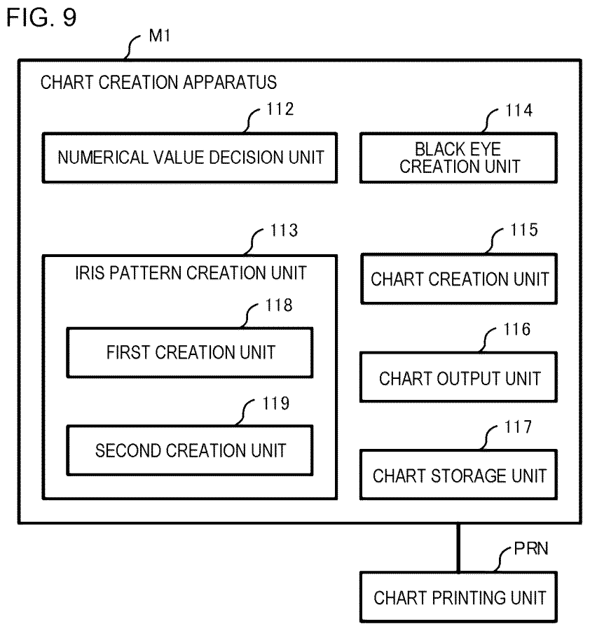

FIG. 9 is a diagram illustrating a functional configuration example of the chart creation apparatus M1 according to the example embodiment 1.

The chart creation apparatus M1 is an information processing apparatus that creates a chart image including the iris pattern IRP for evaluating at least one of an imaging environment and an imaging setting.

The chart creation apparatus MI includes a numerical value decision unit 112, an iris pattern creation unit 113, a black eye creation unit 114, a chart creation unit 115, a chart output unit 116, a chart storage unit 117, and a chart printing unit PRN.

The numerical value decision unit 112 decides a plurality of numerical values associated with each of the plurality of small regions 105_j.

Specifically, for example, the numerical value decision unit 112 may decide a plurality of numerical values associated with each of the plurality of small regions 105_j according to a predetermined rule. For example, the numerical value decision unit 112 may generate a random number for each of the plurality of small regions 105_j, and decide a plurality of numerical values associated with each of the plurality of small regions 105_j, based on the generated random number. The random number may be any of a true random number and a pseudo random number.

In a case where a random number is used, for example, the numerical value decision unit 112 may hold, in advance, information that associates a range of a generated random number with a numerical value. In this way, the numerical value decision unit 112 can decide a plurality of numerical values associated with each of the plurality of small regions 105_j by obtaining, from the information, a numerical value associated with a random number generated for each of the plurality of small regions 105_j.

The iris pattern creation unit 113 creates the iris pattern IRP in which the plurality of small regions 105_j have brightness according to each associated numerical value.

Specifically, for example, the iris pattern creation unit 113 functionally includes a first creation unit 118 and a second creation unit 119.

The first creation unit 118 creates a rectangular pattern in which each of a plurality of small rectangular regions acquired by dividing a rectangular region has brightness according to a plurality of numerical values.

The second creation unit 119 creates the iris pattern IRP by deforming the rectangular pattern into a band annular shape. The second creation unit 119 creates the iris pattern IRP by, for example, performing a computation for converting a polar coordinate system into an orthogonal coordinate system on the rectangular pattern.

The black eye creation unit 114 creates the black eye image 102 formed of the pupil region 103 with a circular shape being associated with a pupil, and the iris region 104 being circumscribed on the pupil region 103 and provided with the iris pattern IRP.

The chart creation unit 115 creates a chart image including the one or the plurality of created black eye images 102.

The chart output unit 116 outputs the created chart image to at least one of the chart storage unit 117, the chart printing unit PRN, and the like.

The chart storage unit 117 is a storage unit for storing a chart image being output from the chart output unit 116. The chart printing unit PRN prints a chart image being output from the chart output unit 116. The chart printing unit PRN may be a printing apparatus such as a printer.

FIG. 8 is referred again.

The imaging apparatus CM is an apparatus that images the test chart 100 or a chart image.

Specifically, for example, the imaging apparatus CM may image the test chart 100 installed at a predetermined place. Further, for example, the imaging apparatus CM may image a screen being installed at a predetermined place and displaying the chart image. In this way, the chart image can be imaged. Note that, an example of displaying the chart image will be described below in the other example embodiment.

In a case where the imaging apparatus CM images the test chart 100 or the chart image, the imaging apparatus CM generates a chart imaging image being an image in which the test chart 100 or the chart image is imaged. The chart imaging image includes the test chart 100 or the chart image. Such an imaging apparatus CM is, for example, a camera.

(Functional Configuration Example of Evaluation Apparatus M2 according to Example Embodiment 1)

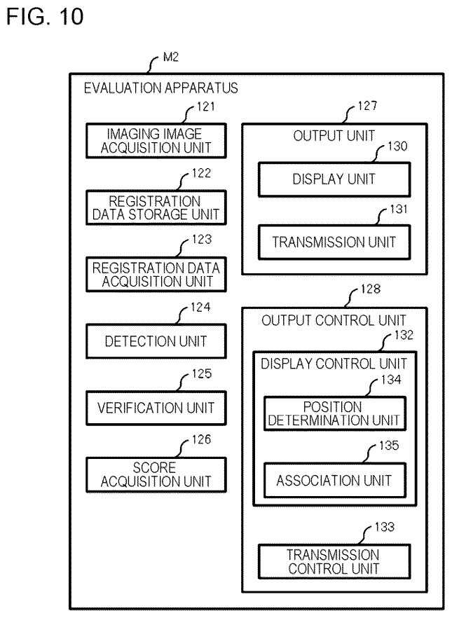

FIG. 10 is a diagram illustrating a functional configuration example of the evaluation apparatus M2 according to the example embodiment 1.

The evaluation apparatus M2 is an information processing apparatus for evaluating at least one of an iris pattern and a chart imaging image. Based on the evaluation, a user can evaluate at least one of an imaging environment and an imaging setting.

The evaluation apparatus M2 includes the imaging image acquisition unit 121, a registration data storage unit 122, the registration data acquisition unit 123, the detection unit 124, the verification unit 125, the score acquisition unit 126, an output unit 127, and the output control unit 128.

The imaging image acquisition unit 121 acquires a chart imaging image from the imaging apparatus CM.

The registration data storage unit 122 is a storage unit for storing registration data in advance. The registration data include the iris pattern IRP included in the test chart 100 or the chart image being imaged by the imaging apparatus CM.

The registration data acquisition unit 123 acquires the registration data. Specifically, for example, the registration data acquisition unit 123 acquires the registration data from the registration data storage unit 122. Note that, the registration data acquisition unit 123 may acquire the registration data from, for example, another apparatus and the like via the network N instead of the registration data storage unit 122.

The detection unit 124 detects the iris pattern IRP from the chart imaging image being acquired by the imaging image acquisition unit 121.

A general technique such as pattern matching and a machine learning model may be used for a method for detecting the iris pattern IRP by the detection unit 124. The method for detecting the iris pattern IRP by the detection unit 124 is desirably the same as a method for detecting an iris from an image in which a target is imaged by the iris recognition.

For example, in a case where a machine learning model is used, the detection unit 124 inputs a chart imaging image to an iris detection model that has trained to detect an iris from an image in which a target is imaged, and acquires an image including the iris pattern IRP. In training of the iris detection model, for example, training leaning using training data providing a correct label indicating a position of an iris to an image in which a target is imaged may be performed.

The verification unit 125 verifies the iris pattern IRP detected by the detection unit 124 with the iris pattern IRP included in the registration data.

Specifically, for example, the verification unit 125 obtains a degree of similarity between the iris pattern IRP detected by the detection unit 124 and the iris pattern IRP included in the registration data. For example, in a case where a degree of similarity is equal to or more than a threshold value, the iris pattern IRP detected by the detection unit 124 coincides with the iris pattern IRP included in the registration data, and the verification unit 125 determines that verification succeeds. Further, for example, in a case where a degree of similarity is less than the threshold value, the iris pattern IRP detected by the detection unit 124 does not coincide with the iris pattern IRP included in the registration data, and the verification unit 125 determines that verification fails.

A general technique such as pattern matching and a machine learning model may be used for a method for obtaining a degree of similarity. The method for obtaining a degree of similarity is desirably the same as a method for obtaining a degree of similarity used in the iris recognition using an image in which a target is imaged.

For example, in a case where a machine learning model is used, the verification unit 125 may input an image including the iris pattern IRP detected by the detection unit 124 to a feature value extraction model that has trained to extract a feature value from an image of an iris being detected by using an iris detection model. In this way, the verification unit 125 can acquire a feature value of the iris pattern IRP detected by the detection unit 124.

Further, the verification unit 125 may input an image including the iris pattern IRP included in the registration data to the feature value extraction model. In this way, the verification unit 125 can acquire a feature value of the iris pattern IRP included in the registration data.

Then, the verification unit 125 may obtain a degree of similarity between the acquired two feature values. In this way, a degree of similarity between the iris pattern IRP detected by the detection unit 124 and the iris pattern IRP included in the registration data can be obtained.

The score acquisition unit 126 obtains an evaluation score, based on a result of at least one of the detection performed by the detection unit 124 and the verification performed by the verification unit 125. The evaluation score is an index for evaluating at least one of the iris pattern IRP and a chart imaging image.

The evaluation score includes, for example, one or more of (1) an evaluation score for each iris pattern IRP included in a chart imaging image, and (2) an evaluation score for the chart imaging image.
(1) The evaluation score includes, for example, a degree of similarity to the iris pattern IRP included in the registration data, a degree of reliability indicating a degree that the degree of similarity can be relied on, a detection time required for detecting the iris pattern IRP from the chart imaging image, a histogram, and the like.
(2) The evaluation score includes, for example, a total value and an average value of degrees of similarity that are obtained for all of the iris patterns IRP included in the chart imaging image, a total value and an average value of degrees of reliability, a total value and an average value of detection times, and the like.

The output unit 127 outputs a value based on the evaluation score. The output unit 127 includes, for example, a display unit 130 and a transmission unit 131.

The display unit 130 displays the value based on the evaluation score. The display unit 130 according to the present example embodiment displays the evaluation score.

The transmission unit 131 transmits the value based on the evaluation score to another apparatus and the like via the network N.

The output control unit 128 causes the output unit 127 to output the value based on the evaluation score. The output control unit 128 includes a display control unit 132 that causes the display unit 130 to display the value based on the evaluation score, and a transmission control unit 133 that causes the transmission unit 131 to transmit the value based on the evaluation score.

The display control unit 132 causes the display unit 130 to display the evaluation score obtained by the score acquisition unit 126 in association with at least one of the iris pattern IRP and the chart imaging image that are related to the evaluation score.

Specifically, for example, the display control unit 132 includes a position determination unit 134 and an association unit 135.

The position determination unit 134 determines a position, in the chart imaging image, of the iris pattern IRP included in the registration data, based on a result of verification performed by the verification unit 125.

The association unit 135 causes the display unit 130 to display the evaluation score related to the iris pattern IRP and the chart imaging image in association with the iris pattern IRP or the chart imaging image, based on the determined position. In other words, for example, for (1) the evaluation score, the association unit 135 causes the display unit 130 to display the evaluation score in association with the associated iris pattern IRP. Further, for example, for (2) the evaluation score, the association unit 135 causes the display unit 130 to display the evaluation score in association with the chart imaging image.

The functional configuration example of the information processing system 110 according to the example embodiment 1 is mainly described above. Hereinafter, a physical configuration example of the information processing system 110 according to the example embodiment 1 will be described.

### (Physical Configuration Example of Chart Creation Apparatus M1)

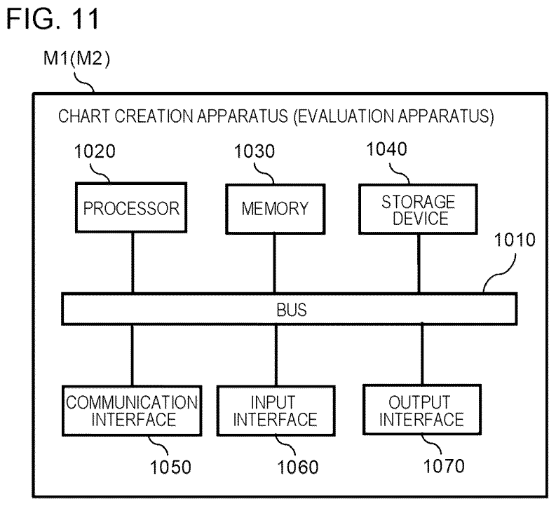

FIG. 11 is a diagram illustrating a physical configuration example of the chart creation apparatus M1 according to the example embodiment 1. The chart creation apparatus MI physically includes, for example, a bus 1010, a processor 1020, a memory 1030, a storage device 1040, a communication interface 1050, an input interface 1060, and an output interface 1070.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function of the chart creation apparatus M1. The processor 1020 reads each program module onto the memory 1030 and executes the program module, and a function associated with the program module is achieved.

The communication interface 1050 is an interface for connecting the chart creation apparatus M1 to the network N.

The input interface 1060 is an interface for a user to input information. The input interface 1060 is formed of, for example, a touch panel, a keyboard, a mouse, and the like.

The output interface 1070 is an interface for providing information to a user. The output interface 1070 is formed of, for example, a liquid crystal panel, an organic electro-luminescence (EL) panel, and the like.

### (Physical Configuration Example of Evaluation Apparatus M2)

The evaluation apparatus M2 may be physically configured similarly to the chart creation apparatus M1 (see FIG. 11). However, the storage device 1040 of the evaluation apparatus M2 stores a program module for achieving a function of the evaluation apparatus M2. The communication interface 1050 of the evaluation apparatus M2 is an interface for connecting the evaluation apparatus M2 to the network N.

Note that, the chart creation apparatus MI and the evaluation apparatus M2 may be physically configured by one apparatus, or may be configured by physically dividing the functions of the chart creation apparatus M1 and the evaluation apparatus M2 into a plurality of apparatuses.

The configuration example of the information processing system 110 according to the example embodiment 1 is described above. Hereinafter, an operation example of the information processing system 110 according to the example embodiment 1 will be described.

(Operation of Information Processing System 110 according to Example Embodiment 1)

The information processing system 110 performs information processing including chart creation processing performed by the chart creation apparatus M1 and evaluation processing performed by the evaluation apparatus M2.

### (Example of Chart Creation Processing According to Example Embodiment 1)

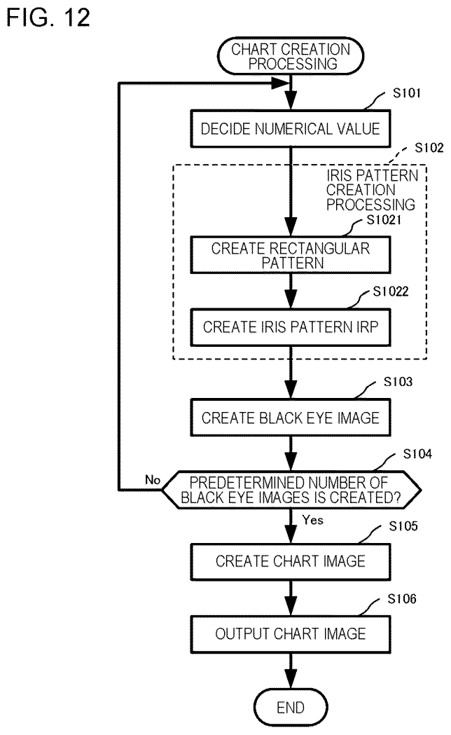

FIG. 12 is a flowchart illustrating an example of the chart creation processing according to the example embodiment 1.

The chart creation processing is processing for creating a chart image including the iris pattern IRP for evaluating at least one of an imaging environment and an imaging setting. The chart creation processing starts in response to, for example, an instruction from a user. Further, before the chart creation processing starts, for example, the number and a resolution of the iris patterns IRP included in a chart image to be created are set by an input of a user. In the following example, it is assumed that the number of the iris patterns IRP is ten, and a resolution of each of the iris patterns IRP is the same.

Note that, similarly to the number of the black eye images 102 included in the test chart 100, the number of the iris patterns IRP included in the chart image is not limited to ten, and may be one or more.

The numerical value decision unit 112 decides a plurality of numerical values associated with each of the plurality of small regions 105_j included in the iris pattern IRP (step S101).

Specifically, for example, it is assumed that the numerical value decision unit 112 generates a random number greater than 0 and equal to or less than 1, and the iris pattern IRP is a pattern with monochrome two gray levels.

In this case, for example, the numerical value decision unit 112 may decide “0” or “1” as a numerical value associated with the small region 105_j, based on the random number generated for the small region 105_j. Specifically, in a case where the random number is equal to or less than 0.5, the numerical value decision unit 112 may decide “0” as a numerical value associated with the small region 105_j. Further, in a case where the random number is greater than 0.5, the numerical value decision unit 112 may decide “1” as a numerical value associated with the small region 105_j.

The iris pattern creation unit 113 creates the iris pattern IRP in which the plurality of small regions 105_j have brightness according to each associated numerical value (step S102).

Specifically, for example, the first creation unit 118 creates a rectangular pattern in which each of a plurality of small rectangular regions acquired by dividing a rectangular region has brightness according to a plurality of numerical values (step S1021).

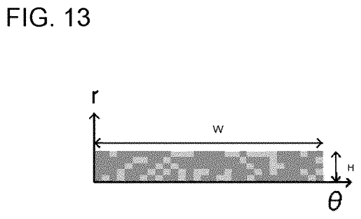

FIG. 13 is a diagram illustrating one example of a rectangular pattern according to the example embodiment 1. The rectangular pattern is an example of being formed of a plurality of small rectangular regions acquired by dividing a rectangular region with a width W and a height H into a grid pattern. The first creation unit 118 fills each of the plurality of small rectangular regions with brightness according to the numerical value decided in step S101. The number of the plurality of small rectangular regions is the same as the number of the small regions 105_j configuring the iris pattern IRP.

For example, it is assumed that the numerical value “0” corresponds to white, and the numerical value “1” corresponds to “black”. The first creation unit 118 fills the plurality of small rectangular regions with white or black according to the numerical value decided in step S101 in a predetermined order. A rectangular pattern is created by performing this on all of the small rectangular regions.

The second creation unit 119 creates the iris pattern IRP by deforming the rectangular pattern into a band annular shape (step S1022).

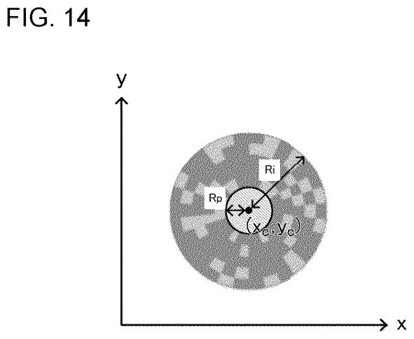

FIG. 14 is a diagram illustrating one example of the iris pattern IRP according to the example embodiment 1. The second creation unit 119 creates the iris pattern IRP as illustrated in FIG. 14 by performing a computation for converting a polar coordinate system into an orthogonal coordinate system on the rectangular pattern illustrated in FIG. 13. FIG. 14 illustrates an example in which the iris pattern IRP with an inner diameter Rp and an outer diameter Ri with (Xc, Yc) as the center.

The black eye creation unit 114 creates the black eye image 102 (step S103).

Specifically, for example, the black eye creation unit 114 creates the black eye image 102 by setting the iris pattern IRP created in step S1022 as the iris region 104 and filling the pupil region 103 inside the iris region 104 with black.

The black eye creation unit 114 determines whether a predetermined number of the black eye images 102 is created (step S104).

In a case where it is determined that the predetermined number of the black eye images 102 is not created (step S104; No), steps S101 to S103 are performed again. The predetermined number herein means the number of the iris patterns IRP included in a chart image, and is ten as described above in the present example embodiment. Thus, steps S101 to S103 are repeatedly performed until the ten black eye images 102 are created. As a result, the ten black eye images 102 are created.

Further, the iris pattern IRP is created based on the numerical value decided in step S101. Thus, there is a high possibility that each of the iris patterns IRP created in step S102 being repeatedly performed has a pattern different from each other. Particularly, in a case where the random number is generated and the numerical value is decided in step S101, a possibility that each of the iris patterns IRP has a pattern different from each other is extremely high. Therefore, the plurality of black eye images 102 including the iris patterns IRP different from each other can be created.

In a case where it is determined that the predetermined number of the black eye images 102 is created (step S104; Yes), the chart creation unit 115 creates a chart image including the black eye images 102 created in step S104 (step S105).

Specifically, for example, the chart creation unit 115 creates a chart image by disposing each of the ten black eye images 102 created in step S104 in a predetermined position in the chart image. The ten black eye images 102 are disposed in positions different from each other.

The chart output unit 116 outputs the chart image created in step S105 (step S106), and the chart creation processing ends.

Specifically, for example, the chart output unit 116 outputs the chart image to at least one of the chart storage unit 117, the chart printing unit PRN, and the like as described above.

In a case where the chart image is output to the chart printing unit PRN, the chart printing unit PRN prints the chart image onto a medium such as the sheet 101, paper, and a sticker. The test chart 100 can be created by sticking the paper or the sticker on which the chart image is printed to the sheet 101.

### (Example of Evaluation Processing According to Example Embodiment 1)

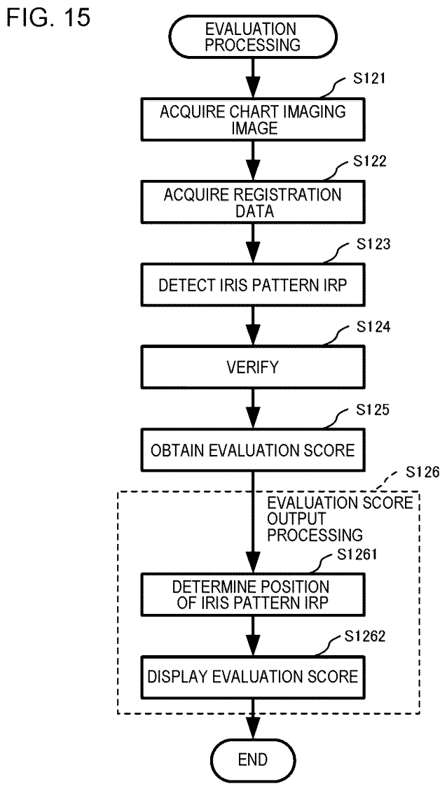

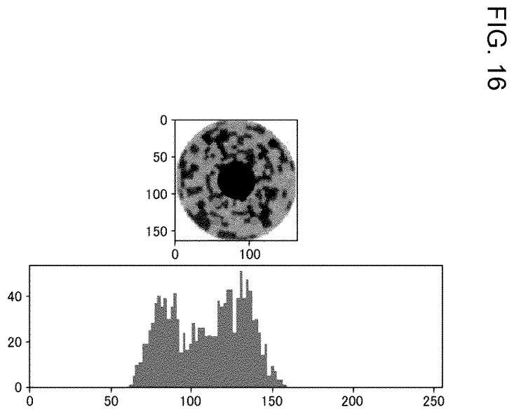

FIG. 15 is a flowchart illustrating an example of the evaluation processing according to the example embodiment 1.

The evaluation processing is processing for evaluating at least one of the iris pattern IRP and a chart imaging image including the iris pattern IRP.

Before the evaluation processing starts, for example, a user disposes the one or the plurality of test charts 100 or chart images in a predetermined position. In the present example embodiment, a board to which the plurality of test charts 100 are arranged vertically and horizontally and attached is assumed to be disposed in a predetermined position. Then, in a case where the imaging apparatus CM that receives an instruction of the user images the plurality of test charts 100, and creates a plurality of chart imaging images each including the plurality of test charts 100, the evaluation apparatus M2 starts the evaluation processing.

The imaging image acquisition unit 121 acquires the chart imaging image generated by the imaging apparatus CM from the imaging apparatus CM (step S121).

The registration data acquisition unit 123 acquires registration data from the registration data storage unit 122 (step S122).

The detection unit 124 detects the iris pattern IRP from the chart imaging image acquired in step S121 (step S123).

At this time, the detection unit 124 may time a detection time required for detecting the iris pattern IRP from the chart imaging image.

The verification unit 125 verifies the iris pattern IRP detected by the detection unit 124 with the iris pattern IRP included in the registration data (step S124).

Specifically, for example, the verification unit 125 verifies each of the iris patterns IRP included in the registration data with the iris pattern IRP in the chart imaging image.

For example, in a case where the verification succeeds, the verification unit 125 associates, with each other, the iris patterns IRP in the registration data and in the chart imaging image that have succeeded in the verification. At this time, the verification unit 125 may hold, for example, a degree of similarity between the iris patterns IRP in the registration data and in the chart imaging image that have succeeded in the verification, in association with the iris patterns IRP. Further, the verification unit 125 may also hold a degree of reliability of the obtained degree of similarity in association with the iris patterns IRP that have succeeded in verification.

Further, for example, in a case where the iris pattern IRP in the chart imaging image is unclear and the like, the iris pattern IRP and also the iris pattern IRP included in the registration data may not succeed in the verification. In this case, for example, the verification unit 125 may hold the iris pattern IRP included in the registration data in association with information about the associated iris pattern IRP in the chart imaging image is unclear.

The score acquisition unit 126 obtains an evaluation score, based on a result of at least one of the detection performed by the detection unit 124 (i.e., detection processing in step S123) and the verification performed by the verification unit 125 (i.e., verification processing in step S124) (step S125).

For example, as described above, the evaluation score includes (1) a degree of similarity and a degree of reliability being obtained in step S124 for each of the iris patterns IRP detected by the detection unit 124, and a detection time being timed in step S123. Further, for example, the evaluation score includes (2) a total value and an average value of degrees of similarity, degrees of reliability, and detection times of all of the iris patterns IRP (i.e., a whole of the iris patterns IRP) included in the chart imaging image. Note that, the evaluation score may include at least one of the examples cited herein, or may include a score other than the examples cited herein.

The output unit 127 outputs a value based on the evaluation score obtained in step S125 (step S126).

In step S126 according to the present example embodiment, the display control unit 132 causes the display unit 130 to display the evaluation score obtained in step S125 in association with at least one of the iris pattern IRP and the chart imaging image that are related to the evaluation score.

Specifically, for example, the position determination unit 134 determines a position, in the chart imaging image of the associated iris pattern IRP, of each of the iris patterns IRP included in the registration data, based on a result of the verification processing in step S124 (step S1261).

For example, in a case where verification of the iris pattern IRP included in the registration data succeeds, the iris pattern IRP is associated with the iris pattern IRP in the chart imaging image that has succeeded in verification with the iris pattern IRP. Thus, for such an iris pattern IRP included in the registration data, the position determination unit 134 can determine a position in the chart imaging image of the associated iris pattern IRP.

Further, for example, in a case where verification of the iris pattern IRP included in the registration data fails, which of the iris patterns IRP in the chart imaging image the iris pattern IRP included in the registration data is associated with is unclear. Thus, for such an iris pattern IRP included in the registration data, a position in the chart imaging image may not be determined.

The association unit 135 causes the display unit 130 to display an image in which the evaluation score is associated with the iris pattern IRP or the chart imaging image, based on the position determined in step S1261 (step S1262), and the evaluation processing ends.

Specifically, for example, for (1) the evaluation score, the association unit 135 causes the display unit 130 to display an image in which the evaluation score is associated with the iris pattern IRP. For (2) the evaluation score, the association unit 135 causes the display unit 130 to display an image in which the evaluation score is associated with the chart imaging image.

For example, display using overlapping display and a balloon, and the like may be used for association. In other words, for example, the evaluation score may be associated by being displayed over the image of the iris pattern IRP or the image of the chart imaging image.

Further, for example, the evaluation score may be associated by being displayed in a balloon indicating the image of the iris pattern IRP or the image of the chart imaging image.

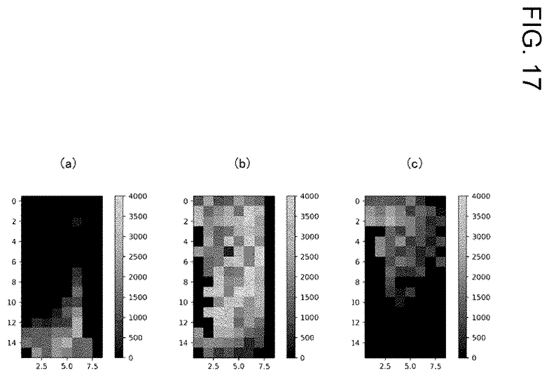

FIG. 16 is a diagram illustrating a first display example of an evaluation score according to the example embodiment 1. FIG. 16 illustrates a display example in which an image of the iris pattern IRP is associated with a histogram as an evaluation score related to the iris pattern IRP.

In FIG. 17, FIG. 17(a) to 17(c) that are diagrams illustrating a second display example of an evaluation score according to the example embodiment 1 illustrate display examples of the evaluation score in a case where a board to which the plurality of test charts 100 are arranged and attached is disposed at a different distance from the imaging apparatus CM and is imaged. In each of FIG. 17(a) to 17(c), an evaluation score of each of a plurality of chart imaging images is indicated in association with the chart imaging image by changing a color or depth of an image in a position of the chart imaging image.

For example, in the example illustrated in FIG. 17(b), a whole of the plurality of chart imaging images has a substantially excellent evaluation score. In contrast, in the examples illustrated in FIG. 17(a) and 17(c), a part of the plurality of chart imaging images does not have a substantially excellent evaluation score. In this way, an imaging distance for creating the example in FIG. 17(b) is suitable for imaging for the iris recognition, and, in this case, it is clear that an image with a wide angle of view being suitable for the iris recognition can be acquired.

In a case where an evaluation score is high, an imaging environment and an imaging setting suitable for imaging for the iris recognition can be confirmed by performing such evaluation processing. Further, in a case where an evaluation score is low, there is a possibility that an imaging environment or an imaging setting may not be suitable for imaging for the iris recognition, and thus a user can take action such as changing the imaging environment or the imaging setting.

In a case where the test chart 100 including the plurality of iris patterns IRP is used, whether a whole of the test chart 100 has an imaging environment and an imaging setting suitable for imaging for the iris recognition can be confirmed by referring to an evaluation score. Thus, whether an angle of view wider than a case of one iris pattern IRP has an imaging environment and an imaging setting suitable for imaging for the iris recognition can be confirmed.

In a case where the plurality of test charts 100 are used, whether an angle of view further wider than a case of one test chart 100 has an imaging environment and an imaging setting suitable for imaging for the iris recognition can be confirmed.

As described above, according to the example embodiment 1, the test chart 100 includes the iris pattern IRP for evaluating at least one of an imaging environment and an imaging setting.

In this way, at least one of an imaging environment and an imaging setting can be easily evaluated, and setting and the like can be changed as necessary. Therefore, an image suitable for the iris recognition can be easily acquired.

According to the example embodiment 1, the iris pattern IRP is a pattern in which brightness is different from each other in at least a part of the plurality of small regions 105_j acquired by dividing the iris region 104 with a band annular shape being associated with an iris.

In this way, the iris pattern IRP imitating an iris can be acquired, and thus at least one of an imaging environment and an imaging setting can be easily evaluated, and setting and the like can be changed as necessary. Therefore, an image suitable for the iris recognition can be easily acquired.

According to the example embodiment 1, the test chart 100 includes the black eye image 102 formed of the pupil region 103 with a circular shape being associated with a pupil, and the iris region 104 being circumscribed on the pupil region 103 and provided with the iris pattern IRP. The plurality of small regions 105_j are regions acquired by dividing the iris region 104 by the one or the plurality of circles CR that are concentric with the pupil region 103 and the one or the plurality of straight lines LN passing through the center of the pupil region 103.

In this way, the iris pattern IRP imitating an iris can be acquired, and thus at least one of an imaging environment and an imaging setting can be easily evaluated, and setting and the like can be changed as necessary. Therefore, an image suitable for the iris recognition can be easily acquired.

According to the example embodiment 1, the black eye image 102 is plural. The plurality of black eye images 102 are provided in positions different from each other.

In this way, whether an angle of view wider than a case of one black eye image 102 has an imaging environment and an imaging setting suitable for imaging for the iris recognition can be confirmed. Thus, work for repeating processing of disposing a test chart in a different position with respect to the imaging apparatus CM, imaging the test chart, and performing evaluation in order to confirm a wide angle of view can be reduced. Therefore, an image suitable for the iris recognition can be more easily acquired.

According to the example embodiment 1, the plurality of black eye images 102 include iris patterns different from each other.

In this way, a position of the iris pattern IRP that succeeds or fails in recognition with respect to the imaging apparatus CM can be more easily and accurately determined than a case where the plurality of black eye images 102 have the same iris pattern. Thus, at least one of an imaging environment and an imaging setting can be easily and accurately evaluated, and setting and the like can be changed as necessary. Therefore, an image suitable for the iris recognition can be more easily acquired.

According to the example embodiment 1, an outer diameter of the iris region 104 is equal to an outer diameter of an actual iris.

In this way, the iris pattern IRP closer to an actual iris can be acquired, and thus at least one of an imaging environment and an imaging setting can be easily and accurately evaluated, and setting and the like can be changed as necessary. Therefore, an image suitable for the iris recognition can be more easily acquired.

According to the example embodiment 1, an outer diameter of the iris region 104 is 10 millimeters to 12 millimeters.

In this way, the iris pattern IRP closer to an actual iris can be acquired, and thus at least one of an imaging environment and an imaging setting can be easily and accurately evaluated, and setting and the like can be changed as necessary. Therefore, an image suitable for the iris recognition can be more easily acquired.

According to the example embodiment 1, the test chart 100 includes the sheet 101. The iris pattern IRP is provided on the sheet 101.

In this way, the iris pattern IRP can be easily imaged. Therefore, an image suitable for the iris recognition can be easily acquired.

According to the example embodiment 1, the chart creation apparatus MI creates a chart image including the iris pattern IRP for evaluating at least one of an imaging environment and an imaging setting.

In this way, a chart image including the iris pattern IRP can be easily acquired, and thus at least one of an imaging environment and an imaging setting can be easily evaluated, and setting and the like can be changed as necessary. Therefore, an image suitable for the iris recognition can be easily acquired.

According to the example embodiment 1, the chart creation apparatus M1 includes the numerical value decision unit 112, the iris pattern creation unit 113, the black eye creation unit 114, and the chart creation unit 115.

The numerical value decision unit 112 decides a plurality of numerical values associated with each of the plurality of small regions 105_j. The iris pattern creation unit 113 creates the iris pattern IRP in which the plurality of small regions 105_j have brightness according to each associated numerical value.

The black eye creation unit 114 creates the black eye image 102 formed of the pupil region 103 with a circular shape being associated with a pupil, and the iris region 104 being circumscribed on the pupil region 103 and provided with the iris pattern IRP. The chart creation unit 115 creates a chart image including the one or the plurality of black eye images 102.

In this way, a chart image including the iris pattern IRP can be easily acquired, and thus at least one of an imaging environment and an imaging setting can be easily evaluated, and setting and the like can be changed as necessary. Therefore, an image suitable for the iris recognition can be easily acquired.

Further, a chart image including the iris pattern IRP can be acquired without using an iris image of an actual person and the like. Thus, even in a case where the iris pattern IRP and the like are leaked to a third person, no privacy is leaked. Therefore, privacy can be protected.

According to the example embodiment 1, the iris pattern creation unit 113 includes the first creation unit 118 and the second creation unit 119. The first creation unit 118 creates a rectangular pattern in which each of a plurality of small rectangular regions acquired by dividing a rectangular region has brightness according to a plurality of numerical values. The second creation unit 119 creates the iris pattern IRP by deforming the rectangular pattern into a band annular shape.

In this way, a chart image including the iris pattern IRP can be easily acquired, and thus at least one of an imaging environment and an imaging setting can be easily evaluated, and setting and the like can be changed as necessary. Therefore, an image suitable for the iris recognition can be easily acquired.

Further, a chart image including the iris pattern IRP can be acquired without using an iris image of an actual person and the like. Thus, even in a case where the iris pattern IRP and the like are leaked to a third person, no privacy is leaked. Therefore, privacy can be protected.

According to the example embodiment 1, the second creation unit 119 creates the iris pattern IRP by performing a computation for converting a polar coordinate system into an orthogonal coordinate system on the rectangular pattern.

In this way, a chart image including the iris pattern IRP can be easily acquired, and thus at least one of an imaging environment and an imaging setting can be easily evaluated, and setting and the like can be changed as necessary. Therefore, an image suitable for the iris recognition can be easily acquired.

Further, a chart image including the iris pattern IRP can be acquired without using an iris image of an actual person and the like. Thus, even in a case where the iris pattern IRP and the like are leaked to a third person, no privacy is leaked. Therefore, privacy can be protected.

According to the example embodiment 1, the evaluation apparatus M2 includes the imaging image acquisition unit 121, the registration data acquisition unit 123, the detection unit 124, the verification unit 125, the score acquisition unit 126, and the output control unit 128.

The imaging image acquisition unit 121 acquires a chart imaging image being an image in which the test chart 100 or a chart image including the iris pattern IRP for evaluating at least one of an imaging environment and an imaging setting is imaged.

The registration data acquisition unit 123 acquires registration data including the iris pattern IRP included in the test chart 100 or the chart image. The detection unit 124 detects the iris pattern IRP from the acquired chart imaging image. The verification unit 125 verifies the detected iris pattern with the iris pattern IRP included in the registration data.

The score acquisition unit 126 obtains an evaluation score for evaluating at least one of the iris pattern IRP and the chart imaging image, based on a result of at least one of the detection and the verification. The output control unit 128 causes the output unit 127 to output a value based on the evaluation score.

In this way, whether an imaging environment and an imaging setting are suitable for imaging for the iris recognition can be easily evaluated by using the test chart 100 or the chart image, and setting and the like can be changed as necessary. Therefore, an image suitable for the iris recognition can be easily acquired.

According to the example embodiment 1, the evaluation score includes at least one of a degree of similarity for each of the iris patterns IRP to an iris pattern included in the registration data, a degree of reliability indicating a degree that the degree of similarity can be relied on, a detection time required for detecting an iris pattern from the chart image, a total value and an average value of the degrees of similarity for a whole of iris patterns included in the chart imaging image, a total value and an average value of the degrees of reliability, and a total value and an average value of the detection times.

Whether an imaging environment and an imaging setting are suitable for imaging for the iris recognition can be easily evaluated by using such an evaluation score, and setting and the like can be changed as necessary. Therefore, an image suitable for the iris recognition can be easily acquired.

According to the example embodiment 1, the output unit 127 includes the display unit 130 that displays an evaluation score. The output control unit 128 includes the display control unit 132 that causes the display unit 130 to display the evaluation score in association with at least one of the iris pattern IRP and the chart imaging image that are related to the evaluation score.

In this way, a user can easily refer to the evaluation score by viewing information displayed on the display unit 130, and thus the user can easily know an evaluation of whether an imaging environment and an imaging setting are suitable for imaging for the iris recognition, and can change setting and the like as necessary. Therefore, an image suitable for the iris recognition can be easily acquired.

According to the example embodiment 1, the test chart 100 or the chart image includes the plurality of black eye images 102 being provided in positions different from each other and including the iris patterns IRP different from each other.

In this way, whether an angle of view wider than a case of one black eye image 102 has an imaging environment and an imaging setting suitable for imaging for the iris recognition can be confirmed. Further, a position of the iris pattern IRP that succeeds or fails in recognition with respect to the imaging apparatus CM can be more easily and accurately determined than a case where the plurality of black eye images 102 have the same iris pattern.

Thus, at least one of an imaging environment and an imaging setting can be easily and accurately evaluated for a wide angle of view, and setting and the like can be changed as necessary. Therefore, an image suitable for the iris recognition can be more easily acquired.

According to the example embodiment 1, the registration data include the plurality of iris patterns IRP included in the test chart 100 or the chart image. The display control unit 132 includes the position determination unit 134 and the association unit 135.

The position determination unit 134 determines a position, in the chart imaging image of the associated iris pattern IRP, of each of the iris patterns IRP included in the registration data, based on a result of verification by the verification unit 125.

The association unit 135 causes the display unit 130 to display the evaluation score in association with the iris pattern IRP or the chart imaging image, based on the determined position.

In this way, a user can easily recognize whether the evaluation score is related to any of the iris pattern IRP and the chart imaging image by viewing information displayed on the display unit 130. Thus, the user can easily know an evaluation of whether an imaging environment and an imaging setting are suitable for imaging for the iris recognition, and can change setting and the like as necessary. Therefore, an image suitable for the iris recognition can be easily acquired.

### Example Embodiment 2

In the present example embodiment, an example of displaying a chart image on a screen will be described. In this way, the chart image displayed on the screen can be imaged instead of the test chart 100, at least one of an imaging environment and an imaging setting can be easily evaluated, and setting and the like can be changed as necessary.

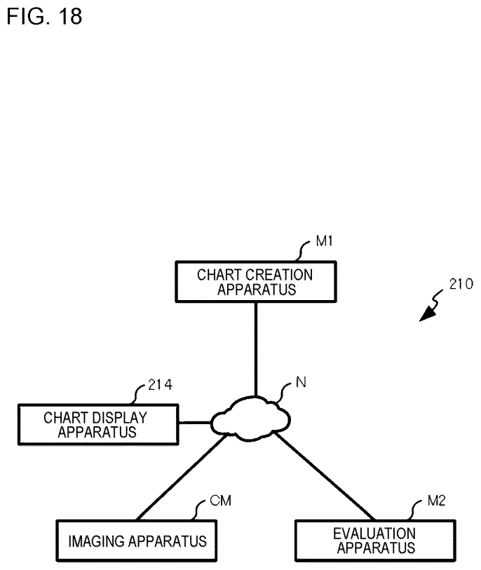

FIG. 18 is a diagram illustrating a configuration example of an information processing system 210 according to an example embodiment 2. The example embodiment 2 further includes a chart display apparatus 214. The chart display apparatus 214 may be connected to a chart creation apparatus M1, an imaging apparatus CM, and an evaluation apparatus M2 in such a way as to be able to transmit and receive information to and from one another via a network N. Except for this point, the information processing system 210 may be configured similarly to the information processing system 110 according to the example embodiment 1.

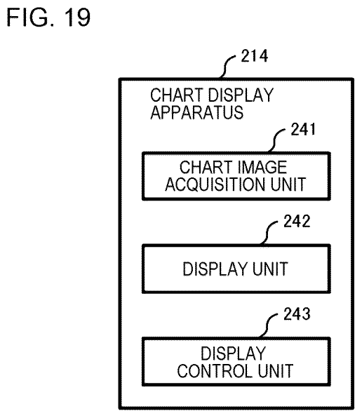

FIG. 19 is a diagram illustrating a functional configuration example of the chart display apparatus 214 according to the example embodiment 2.

The chart display apparatus 214 is an information processing apparatus for displaying a chart image. The chart display apparatus 214 includes a chart image acquisition unit 241, a display unit 242, and a display control unit 243.

The chart image acquisition unit 241 acquires a chart image including an iris pattern for evaluating at least one of an imaging environment and an imaging setting.

The display unit 242 displays various types of information. The display control unit 243 causes the display unit 242 to display the chart image acquired by the chart image acquisition unit 241.

The chart display apparatus 214 may be physically configured similarly to the chart creation apparatus MI according to the example embodiment 1 (see FIG. 11). However, a storage device 1040 of the chart display apparatus 214 stores a program module for achieving a function of the chart display apparatus 214. A communication interface 1050 of the chart display apparatus 214 is an interface for connecting the chart display apparatus 214 to the network N.

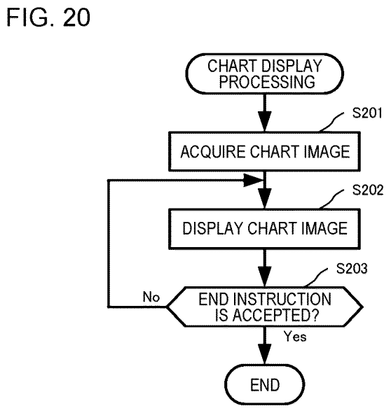

FIG. 20 is a flowchart illustrating one example of chart display processing according to the example embodiment 2. The chart display processing is information processing for displaying a chart image. The chart display processing starts in response to, for example, an instruction from a user.

The chart image acquisition unit 241 acquires a chart image including an iris pattern for evaluating at least one of an imaging environment and an imaging setting (step S201).

Specifically, for example, the chart image acquisition unit 241 may acquire a chart image from, for example, the chart creation apparatus M1. Note that, the chart image acquisition unit 241 may acquire a chart image from a storage unit (not illustrated) that stores the chart image.

The display control unit 243 causes the display unit 242 to display the chart image (step S202).

The display control unit 243 determines whether an end instruction for ending display is accepted from the user, for example (step S203).

In a case where it is determined that the end instruction is not accepted (step S203; No), the display control unit 243 repeatedly performs step S202. In this way, the chart image can be continuously displayed on the display unit 242.

In a case where it is determined that the end instruction is accepted (step S203; Yes), the display control unit 243 ends display of the chart image, and the chart display processing ends.

By performing such chart display processing, evaluation processing similar to that in the example embodiment 1 can be performed by using the chart image displayed on the display unit 242 instead of the test chart 100 according to the example embodiment 1. In this case, the user may cause the display unit 242 to display the chart image by disposing the display unit 242 in a predetermined position and performing the chart display processing.

In a case where the chart display apparatus 214 is an information processing apparatus easy to carry such as a tablet terminal, the display unit 242 can be easily disposed.

Further, in a case where a screen of the display unit 242 is sufficiently large, a plurality of chart images may be displayed on the display unit 242. In this case, a method for arranging the plurality of chart images may be appropriately set, and, for example, the plurality of chart images may be arranged vertically and horizontally and disposed similarly to the example embodiment 1. In this way, similarly to the case where the plurality of test charts 100 are used, whether an angle of view further wider than a case of one chart image has an imaging environment and an imaging setting suitable for imaging for the iris recognition can be confirmed.

As described above, according to the example embodiment 2, the chart display apparatus 214 includes the chart image acquisition unit 214 and the display control unit 243.

The chart image acquisition unit 241 acquires a chart image including an iris pattern for evaluating at least one of an imaging environment and an imaging setting. The display control unit 243 causes the display unit 242 to display the chart image acquired by the chart image acquisition unit 241.

In this way, at least one of an imaging environment and an imaging setting can be easily evaluated, and setting and the like can be changed as necessary. Therefore, an image suitable for the iris recognition can be easily acquired.

### Example Embodiment 3

In the present example embodiment, an example of a specific test chart 100 will be described.

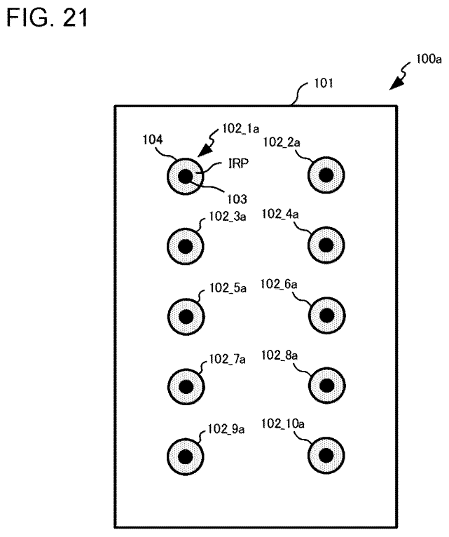

FIG. 21 is a diagram illustrating an example of the specific test chart 100a according to an example embodiment 3. The specific test chart 100a is an imaging test chart in which resolutions of a plurality of iris patterns IRP are different from each other.

The specific test chart 100a includes a sheet 101 similar to that in the example embodiment 1, and ten specific black eye images 102_1a to 102_10a provided on the sheet 101. In a case where the specific black eye images 102_1a to 102_10a are not particularly distinguished, the specific black eye images 102_1a to 102_10a are also expressed as the “specific black eye image 102a”.

Note that, the number of the specific black eye images 102a included in the specific test chart 100a is not limited to ten, and may be two or more.

Each of the plurality of specific black eye images 102a is the black eye image 102 provided on the specific test chart 100a. In other words, similarly to the black eye image 102 according to the example embodiment 1, each of the plurality of specific black eye images 102a is a region with a pattern imitating a black eye, and is formed of a pupil region 103 and an iris region 104. In the plurality of specific black eye images 102, resolutions of the iris patterns IRP provided in the iris region 104 are different from each other.

As described above, the resolutions of the iris patterns IRP are associated with the number of small regions 105_j. Thus, in the specific test chart 100a, the iris region 104 may be formed of, for example, the plurality of small regions 105_j divided by circles CR and straight lines LN in which the number of at least one of the circles CR and the straight lines LN is different. In other words, for example, a user may decide the number of the circles CR and the straight lines LN for dividing the iris region 104 in such a way that the numbers of the small regions 105_j are different from each other. In this way, the iris region 104 is formed of the plurality of small regions 105_j in numbers different from each other. Therefore, the iris patterns IRP with resolutions different from each other can be acquired.

As described above, according to the example embodiment 3, the iris patterns IRP included in the plurality of specific black eye images 102 have resolutions different from each other. The resolutions of the iris patterns IRP are associated with the number of the small regions 105_j acquired by dividing the iris region IRP.

In this way, a resolution as imaging setting can be easily evaluated, and setting and the like can be changed as necessary. Therefore, an image suitable for the iris recognition can be easily acquired.

### Example Embodiment 4

The specific test chart 100a described in the example embodiment 3 can be created by using the chart creation processing according to the example embodiment 1. In the present example embodiment, a method for creating the specific test chart 100a or a specific test chart image, based on an iris image in which an iris of a person is imaged, unlike the example embodiment 1 will be described.

Herein, the “specific test chart image” is a chart image including a plurality of specific iris patterns IRPa. The “specific iris patterns IRPa” are the iris patterns IRP with resolutions different from each other. In other words, the specific test chart 100a is the imaging test chart 100 provided with the plurality of specific iris patterns IRPa.

The plurality of specific iris patterns IRPa are iris patterns for evaluating a resolution in an imaging setting. A fact that each of the plurality of specific iris patterns IRPa is a pattern in which brightness is different from each other in at least a part of a plurality of small regions 105 j acquired by dividing an iris region 104 with a band annular shape being associated with an iris may be similar to the iris pattern IRP.

The specific test chart 100a or the specific test chart image can be created by using a chart creation apparatus M1 substantially similar to that in the example embodiment 1. Thus, in the present example embodiment, a function of the chart creation apparatus MI according to the present example embodiment will be described mainly with points different from the example embodiment 1 with reference to FIG. 9.

A numerical value decision unit 112 decides a plurality of numerical values associated with each of the plurality of small regions 105_j configuring each of the plurality of specific iris patterns IRPa, based on an iris image in which an iris of a person is imaged.

An iris pattern creation unit 113 creates the plurality of specific iris patterns IRPa in which the plurality of small regions 105_j have brightness according to each associated numerical value. A method for creating each of the plurality of specific iris patterns IRPa by the iris pattern creation unit 113 may be similar to the method for creating the iris pattern IRP by the iris pattern creation unit 113 in the example embodiment 1.

A black eye creation unit 114 creates, for each of the plurality of specific iris patterns IRPa, a specific black eye image 102a formed of a pupil region 103 with a circular shape being associated with a pupil, and the iris region 104 being circumscribed on the pupil region 103 and provided with the specific iris pattern IRPa.

Herein, the specific black eye image 102a is the black eye image 102 including the specific iris pattern IRPa. In other words, the specific black eye images 102a are the black eye images 102 including the iris patterns IRP with resolutions different from each other.

A method for creating the specific black eye image 102a by the black eye creation unit 114 may be similar to the method for creating the black eye image 102 by the black eye creation unit 114 in the example embodiment 1.

A chart creation unit 115 creates a specific test chart image including the plurality of created specific black eye images 102a.

A chart output unit 116 outputs the created specific test chart image to at least one of a chart storage unit 117, a chart printing unit PRN, and the like.

The chart storage unit 117 may store the specific test chart image being output from the chart output unit 116. The chart printing unit PRN may print the specific test chart image being output from the chart output unit 116. Details of the chart printing unit PRN may be similar to those in the example embodiment 1.

The chart creation apparatus MI according to the present example embodiment may be physically configured similarly to the chart creation apparatus MI according to the example embodiment 1 (see FIG. 11).

The specific test chart 100a or the specific test chart image can be created by using chart creation processing substantially similar to that in the example embodiment 1. Thus, in the present example embodiment, the chart creation processing according to the present example embodiment will be described mainly with points different from the example embodiment 1 with reference to FIG. 12.

The numerical value decision unit 112 decides a plurality of numerical values associated with each of the plurality of small regions 105_j included in the specific iris pattern IRPa, based on an iris image in which an iris of a person is imaged (step S101).

Specifically, for example, the numerical value decision unit 112 decides a numerical value associated with the small region 105_j, based on a pixel value of a portion of an iris image associated with each of the plurality of small regions 105_j configuring each of the plurality of specific iris patterns IRPa. For example, the numerical value decision unit 112 may decide a numerical value associated with the small region 105_j by following a predetermined rule according to a total, an average, and the like of pixel values of a portion associated with the small region 105_j.

A numerical value decided by the numerical value decision unit 112 may be associated with a gray level of each of the plurality of small regions 105_j. For example, in a case where brightness of each of the plurality of small regions 105_j is indicated by two gray levels of white and black, a numerical value decided by the numerical value decision unit 112 may be associated in advance with each gray level of white and black.

The iris pattern creation unit 113 creates the specific iris pattern IRPa in which the plurality of small regions 105_j have brightness according to each associated numerical value (step S102). The black eye creation unit 114 creates the specific black eye image 102a (step S103).

The black eye creation unit 114 determines whether a predetermined number of the specific black eye images 102a is created (step S104). In a case where it is determined that the predetermined number of the specific black eye images 102a is not created (step S104; No), steps S101 to S103 are performed again.

In a case where it is determined that the predetermined number of the specific black eye images 102a is created (step S104; Yes), the chart creation unit 115 creates a specific test chart image including the specific black eye images 102a created in step S104 (step S105).

The chart output unit 116 outputs the specific test chart image created in step S105 (step S106), and the chart creation processing ends.

Herein, details of steps S102 to S106 according to the present example embodiment may be substantially similar to each of those according to the example embodiment 1.

In a case where the specific test chart image is output to the chart printing unit PRN, the chart printing unit PRN prints the specific test chart image onto a medium such as a sheet 101, paper, and a sticker similarly to the example embodiment 1. The specific test chart 100a can be created by sticking the paper or the sticker on which the specific test chart image is printed to the sheet 101.

As described above, according to the example embodiment 4, a chart image is the specific test chart image including the plurality of specific iris patterns IRPa that are iris patterns for evaluating a resolution in an imaging setting. Each of the plurality of specific iris patterns IRPa is a pattern in which brightness is different from each other in at least a part of the plurality of small regions 105_j acquired by dividing the iris region 104 with a band annular shape being associated with an iris. Resolutions are associated with the number of the small regions 105_j configuring each of the plurality of specific iris patterns IRPa. Resolutions of the plurality of specific iris patterns IRPa are different from each other.

In this way, the specific test chart 100a or the specific test chart image can be easily acquired, and thus a resolution can be easily evaluated, and setting and the like can be changed as necessary. Therefore, an image suitable for the iris recognition can be easily acquired.

According to the example embodiment 4, the numerical value decision unit 112 decides a plurality of numerical values associated with each of the plurality of small regions 105_j configuring each of the plurality of specific iris patterns IRPa, based on an iris image in which an iris of a person is imaged. The iris pattern creation unit 113 creates the plurality of specific iris patterns IRPa in which the plurality of small regions 105_j have brightness according to each associated numerical value.

The black eye creation unit 114 creates, for each of the plurality of specific iris patterns IRPa, the specific black eye image 102a formed of the pupil region 103 with a circular shape being associated with a pupil, and the iris region 104 being circumscribed on the pupil region 103 and provided with the specific iris pattern IRPa. The chart creation unit 115 creates a specific test chart image including the plurality of created specific black eye images 102a.

In this way, the specific test chart 100a or the specific test chart image can be easily acquired, and thus a resolution can be easily evaluated, and setting and the like can be changed as necessary. Therefore, an image suitable for the iris recognition can be easily acquired.

Further, a case where an iris image is used is limited to the specific test chart image for evaluating a resolution, and thus privacy can be protected.

According to the example embodiment 4, brightness of each of the plurality of small regions 105_j is indicated by two gray levels. The numerical value decision unit 112 decides a numerical value associated with the small region 105_j, based on a pixel value of a portion of an iris image associated with each of the plurality of small regions 105_j configuring each of the plurality of specific iris patterns IRPa. The decided numerical value is associated with the gray level of brightness.

In this way, the specific test chart 100a or the specific test chart image can be easily acquired, and thus a resolution can be easily evaluated, and setting and the like can be changed as necessary. Therefore, an image suitable for the iris recognition can be easily acquired.

Further, a case where an iris image is used is limited to the specific test chart image for evaluating a resolution, and thus privacy can be protected.

### Example Embodiment 5

The method for creating the specific test chart 100 or the specific test chart image is described in the example embodiment 4. In the present example embodiment, an evaluation method of a resolution using the specific test chart 100 or the specific test chart image will be described.

An evaluation of a resolution using the specific test chart 100a or the specific test chart image can be performed by using an evaluation apparatus M2 substantially similar to that in the example embodiment 1. Thus, in the present example embodiment, a function of the evaluation apparatus M2 according to the present example embodiment will be described mainly with points different from the example embodiment 1 with reference to FIG. 10.

An imaging test chart or a chart image according to the present example embodiment is the specific test chart 100a or the specific test chart image including a plurality of specific iris patterns IRPa that are iris patterns for evaluating a resolution in an imaging setting.

A chart imaging image according to the present example embodiment is a specific test chart imaging image in which the specific test chart 100a or the chart image is imaged.

Registration data according to the present example embodiment include a plurality of specific iris patterns included in the specific test chart 100a or the chart image.

An evaluation score according to the present example embodiment includes a resolution evaluation score for evaluating each of the plurality of specific iris patterns IRPa. The resolution evaluation score is at least one of an other person acceptance index, and a degree of similarity between the detected specific iris pattern IRPa and the specific iris pattern IRPa included in the registration data.

Herein, the other person acceptance index is an index indicating a possibility of other person acceptance. Further, the other person acceptance is misidentification of another person who attempts to perform recognition as a person herself/himself. The other person acceptance index is, for example, an index indicating a degree of the other person acceptance for a degree of similarity being evaluated by using any iris database in advance for an recognition instrument.

The other person acceptance index in this case is, for example, a value acquired by converting a degree of similarity between the detected specific iris pattern IRPa and the specific iris pattern IRPa included in the registration data. Note that, the index may be a symbol, a sign, and the like instead of a value.

An imaging image acquisition unit 121 acquires a specific test chart imaging image. A detection unit 124 detects the plurality of specific iris patterns IRPa from the acquired specific test chart imaging image.

A verification unit 125 verifies the plurality of detected specific iris patterns IRPa with the plurality of specific iris patterns IRPa included in the registration data. A score acquisition unit 126 obtains a resolution evaluation score of each of the plurality of specific iris patterns IRPa, based on a result of at least one of the detection and the verification.

An output control unit 128 causes an output unit 127 to output a resolution determined based on the resolution evaluation score.

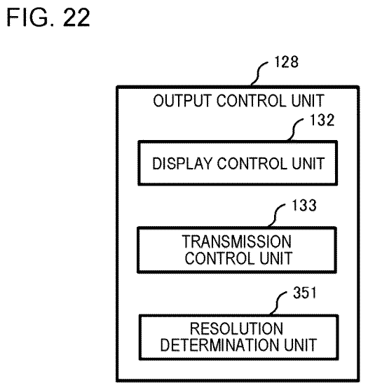

FIG. 22 is a diagram illustrating a functional configuration example of the output control unit 128 according to the example embodiment 5.

The output control unit 128 according to the present example embodiment includes a display control unit 132 and a transmission control unit 133 similar to those in the example embodiment 1, and a resolution determination unit 351.

The resolution determination unit 351 determines a resolution of the specific iris pattern IRPa associated with a maximum resolution evaluation score among a plurality of resolution evaluation scores being obtained for the plurality of specific iris patterns IRPa. The resolution is a value based on an evaluation score.

The transmission control unit 133 according to the present example embodiment causes a transmission unit 131 to transmit the resolution determined by the resolution determination unit 351.

The evaluation apparatus M2 according to the present example embodiment may be physically configured similarly to the evaluation apparatus M2 according to the example embodiment 1 (see FIG. 11).

### (Example of Evaluation Processing According to Example Embodiment 5)

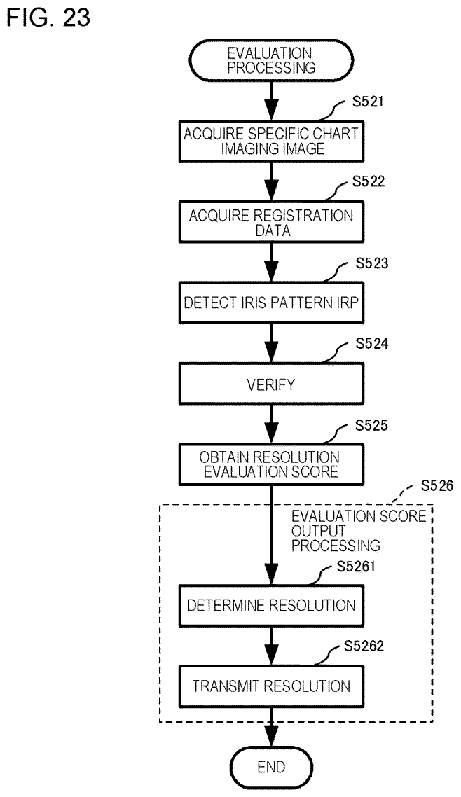

FIG. 23 is a flowchart illustrating an example of evaluation processing according to the example embodiment 5.

Before the evaluation processing starts, a user disposes, for example, the specific test chart 100a or the specific test chart image in a predetermined position. Note that, the specific test chart image can be disposed by a method similar to the method for disposing a chart image in the example embodiment 2. Then, in a case where an imaging apparatus CM that receives an instruction of the user images the specific test chart 100a or the specific test chart image, and creates a chart imaging image including the specific test chart 100a or the specific test chart image, the evaluation apparatus M2 starts the evaluation processing.

The imaging image acquisition unit 121 acquires the specific test chart imaging image generated by the imaging apparatus CM from the imaging apparatus CM (step S521).

A registration data acquisition unit 123 acquires registration data from a registration data storage unit 122 similarly to the example embodiment 1 (step S522). The registration data may include the plurality of specific iris patterns IRPa.

The detection unit 124 detects the specific iris pattern IRPa from the specific test chart imaging image acquired in step S121 (step S523). At this time, the detection unit 124 may time a detection time required for detecting the specific iris pattern IRPa from the specific test chart imaging image similarly to the example embodiment 1.

The verification unit 125 verifies the specific iris pattern IRPa detected by the detection unit 124 with the specific iris pattern IRPa included in the registration data (step S524).

Details of verification processing in step S524 are substantially similar to the verification processing in step S124 according to the example embodiment 1. In other words, in step S524, processing in which the “iris pattern IRP” according to the example embodiment 1 is replaced with the “specific iris pattern IRPa”may be performed.

The score acquisition unit 126 obtains a resolution evaluation score, based on a result of at least one of the detection performed by the detection unit 124 (i.e., detection processing in step S523) and the verification performed by the verification unit 125 (i.e., the verification processing in step S524) (step S525).

Specifically, for example, the score acquisition unit 126 may obtain a resolution evaluation score of each of the plurality of specific iris patterns IRPa.

Further, as described above, the resolution evaluation score may include at least one of an index indicating a possibility of other person acceptance by verification, and a degree of similarity between the detected specific iris pattern IRPa and the specific iris pattern IRPa included in the registration data. Note that, the resolution evaluation score may include an index similar to that of the evaluation score described in the example embodiment 1.

The output unit 127 outputs a value based on the resolution evaluation score obtained in step S525 (step S526).

In step S526 according to the present example embodiment, the transmission control unit 133 causes the transmission unit 131 to transmit a resolution of the specific iris pattern IRPa associated with a maximum resolution evaluation score.

Specifically, for example, the resolution determination unit 351 determines a resolution of the specific iris pattern IRPa associated with a maximum resolution evaluation score among the plurality of resolution evaluation scores being obtained in step S525 (step S5261).

The transmission control unit 133 causes the transmission unit 131 to transmit the resolution determined in step S5261 (step S5262), and the evaluation processing ends.

More specifically, for example, the transmission control unit 133 may cause a resolution to be transmitted to an apparatus (for example, the chart creation apparatus MI described in the example embodiment 1) that creates a chart image. There is a high possibility that a resolution associated with a maximum resolution evaluation score is associated with a resolution of an image suitable for the iris recognition. Thus, the apparatus that creates a chart image can create a chart image with an appropriate resolution. Note that, the display control unit 132 may cause a display unit 130 to display a resolution.

A resolution of an image suitable for the iris recognition can be estimated by performing such evaluation processing.

As described above, according to the example embodiment 5, an imaging test chart or a chart image is the specific test chart 100a or the specific test chart image including the plurality of specific iris patterns IRPa that are iris patterns for evaluating a resolution in an imaging setting.

A chart imaging image is a specific test chart imaging image in which the specific test chart 100a or the chart image is imaged. Registration data include a plurality of specific iris patterns included in the specific test chart 100a or the chart image. An evaluation score includes a resolution evaluation score for evaluating each of the plurality of specific iris patterns IRPa.

The imaging image acquisition unit 121 acquires a specific test chart imaging image.

The detection unit 124 detects the plurality of specific iris patterns IRPa from the acquired specific test chart imaging image. The verification unit 125 verifies the plurality of detected specific iris patterns IRPa with the plurality of specific iris patterns IRPa included in the registration data. The score acquisition unit 126 obtains a resolution evaluation score of each of the plurality of specific iris patterns IRPa, based on a result of at least one of the detection and the verification. The output control unit 128 causes the output unit 127 to output a resolution determined based on the resolution evaluation score.

In this way, a resolution of an image suitable for the iris recognition can be estimated.

Then, the test chart 100 or the chart image using the resolution can be created, at least one of an imaging environment and an imaging setting other than the resolution can be easily accurately evaluated, and setting and the like can be changed as necessary. Therefore, an image suitable for the iris recognition can be more easily acquired.

According to the example embodiment 5, the output unit 127 performs transmission to the apparatus that creates a specific test chart image. The output unit 128 includes the resolution determination unit 351 and the transmission control unit 133.

The resolution determination unit 351 determines a resolution of the specific iris pattern IRPa associated with a maximum resolution evaluation score among a plurality of resolution evaluation scores being obtained for the plurality of specific iris patterns IRPa. The transmission control unit 133 causes the output unit 127 to transmit the determined resolution.

In this way, a resolution of an image suitable for the iris recognition can be transmitted to the apparatus that creates a specific test chart image, and thus the test chart 100 or the chart image using the resolution can be easily created. Then, at least one of an imaging environment and an imaging setting other than the resolution can be easily accurately evaluated by using such test chart 100 or chart image, and setting and the like can be changed as necessary. Therefore, an image suitable for the iris recognition can be more easily acquired.

According to the example embodiment 5, the resolution evaluation score is at least one of an index indicating a possibility of other person acceptance by verification, and a degree of similarity between the detected specific iris pattern IRPa and the specific iris pattern IRPa included in the registration data.

In this way, a resolution of an image suitable for the iris recognition can be accurately estimated. Then, the test chart 100 or the chart image using the resolution can be created, at least one of an imaging environment and an imaging setting other than the resolution can be easily accurately evaluated, and setting and the like can be changed as necessary. Therefore, an image suitable for the iris recognition can be more easily acquired.

### Example Embodiment 6

In the present example embodiment, an example of adjusting an imaging environment, based on an evaluation score, will be described.

An information processing system according to the present example embodiment includes an evaluation apparatus M6 instead of the evaluation apparatus M2 according to the example embodiment 1. Except for this point, the information processing system according to the present example embodiment may be configured similarly to the information processing system 110 according to the example embodiment 1.

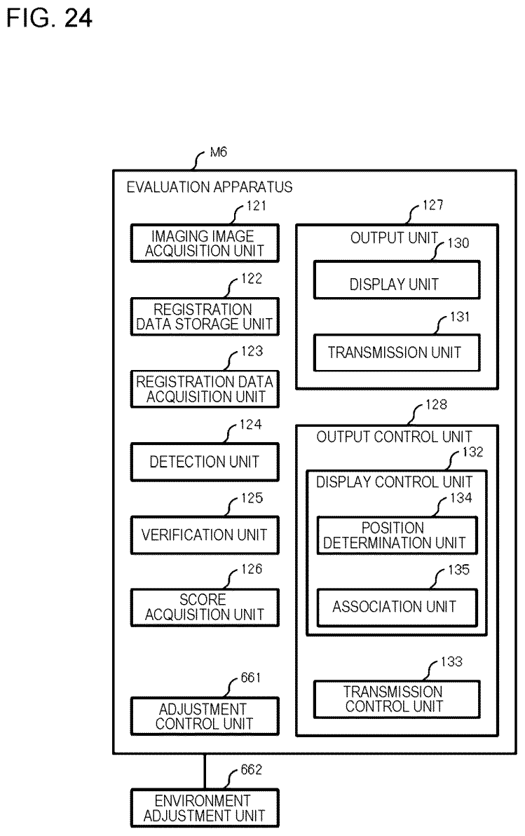

FIG. 24 is a diagram illustrating a functional configuration example of the evaluation apparatus M6 according to the example embodiment 6. The evaluation apparatus M6 includes an adjustment control unit 661 and an environment adjustment unit 662 in addition to the functions included in the evaluation apparatus M2 according to the example embodiment 1.

The environment adjustment unit 662 adjusts an imaging environment, or supports an adjustment to an imaging environment. For example, the environment adjustment unit 662 is an apparatus that opens and closes a curtain of a room in which imaging is performed, an apparatus that displays a message for prompting opening and closing of a curtain, and the like.

An irradiation environment of light can be adjusted by opening and closing a curtain.

The adjustment control unit 661 performs processing for adjusting an imaging environment, based on an evaluation score obtained by a score acquisition unit 126.

Specifically, for example, the adjustment control unit 661 controls the environment adjustment unit 662, based on an evaluation score obtained by the score acquisition unit 126.

The evaluation apparatus M6 may be physically configured similarly to the evaluation apparatus M2 according to the example embodiment 1 (see FIG. 11).

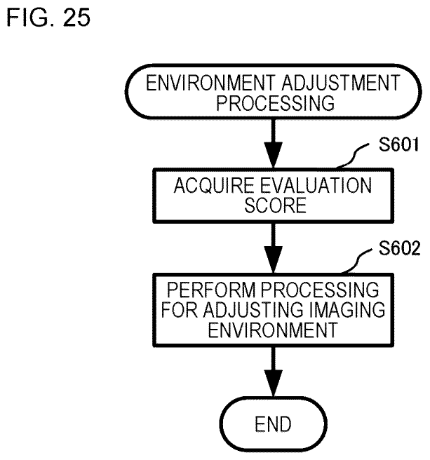

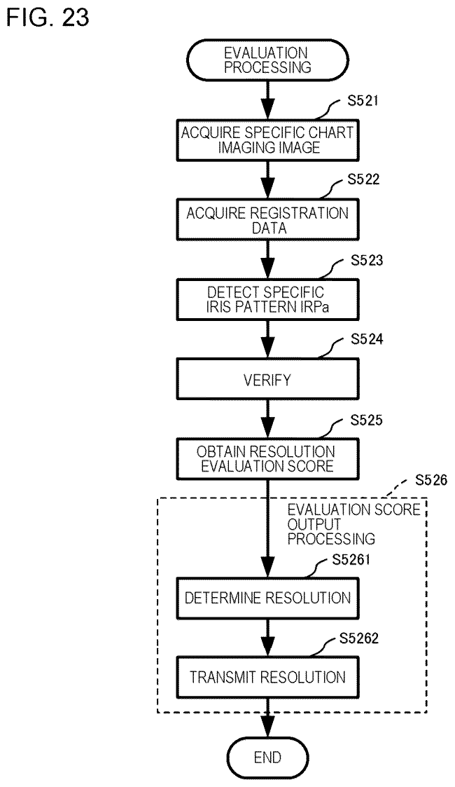

FIG. 25 is a flowchart illustrating an example of environment adjustment processing according to the example embodiment 6. The environment adjustment processing is processing for adjusting an imaging environment. The environment adjustment processing may be performed subsequently to, for example, evaluation processing. In the present example embodiment, description is given by using an example of performing the environment adjustment processing subsequently to the evaluation processing according to the example embodiment 1.

The adjustment control unit 661 acquires an evaluation score obtained in step S125 (step S601).

The adjustment control unit 661 performs the processing for adjusting an imaging environment, based on the evaluation score acquired in step S601 (step S602), and the environment adjustment processing ends.

Specifically, for example, the adjustment control unit 661 performs the processing for adjusting an imaging environment, based on an evaluation score and a predetermined rule. For example, the adjustment control unit 661 may control the environment adjustment unit 662 in order to adjust an imaging environment.

An imaging environment can be adjusted based on an evaluation score by performing such environment adjustment processing, and thus the imaging environment can be easily made suitable for imaging for the iris recognition.

As described above, according to the example embodiment 6, the evaluation apparatus M6 further includes the adjustment control unit 661 that performs the processing for adjusting an imaging environment, based on an evaluation score.

In this way, an imaging environment can be easily made suitable for imaging for the iris recognition. Therefore, an image suitable for the iris recognition can be easily acquired.

While the example embodiments and the modification examples of the present invention have been described with reference to the drawings, the example embodiments and the modification examples are only exemplification of the present invention, and various configurations other than the above-described example embodiments and modification examples can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, the example embodiments and the modification examples described above can be combined within an extent that a content is not inconsistent.

A part or the whole of the above-described example embodiment may also be described in supplementary notes below, which is not limited thereto.

1. An imaging test chart including
an iris pattern for evaluating at least one of an imaging environment and an imaging setting.
   2. The imaging test chart according to supplementary note 1, wherein
the iris pattern is a pattern in which brightness is different from each other in at least a part of a plurality of small regions acquired by dividing an iris region with a band annular shape being associated with an iris.
   3. The imaging test chart according to supplementary note 2, further including
a black eye image formed of a pupil region with a circular shape being associated with a pupil, and the iris region being circumscribed on the pupil region and provided with the iris pattern, wherein
the plurality of small regions are regions acquired by dividing the iris region by one or a plurality of circles that are concentric with the pupil region and one or a plurality of straight lines passing through a center of the pupil region.
   4. The imaging test chart according to supplementary note 3, wherein
the black eye image is plural, and
the plurality of black eye images are provided in positions different from each other.
   5. The imaging test chart according to supplementary note 4, wherein
the plurality of black eye images include iris patterns different from each other.
   6. The imaging test chart according to supplementary note 5, wherein
iris patterns included in the plurality of black eye images have resolutions different from each other, and
resolutions of the iris patterns are associated with a number of the small regions acquired by dividing the iris region.
   7. The imaging test chart according to any one of supplementary notes 2 to 6, wherein an outer diameter of the iris region is equal to an outer diameter of an actual iris.
   8. The imaging test chart according to any one of supplementary notes 2 to 7, wherein an outer diameter of the iris region is from 10 millimeters to 12 millimeters.
   9. The imaging test chart according to any one of supplementary notes 1 to 8, further including
a sheet, wherein
the iris pattern is provided on the sheet.
   10. An information processing apparatus including creating a chart image including an iris pattern for evaluating at least one of an imaging environment and an imaging setting.
   11. The information processing apparatus according to supplementary note 10, wherein the iris pattern is a pattern in which brightness is different from each other in at least a part of a plurality of small regions acquired by dividing an iris region with a band annular shape being associated with an iris.
   12. The information processing apparatus according to supplementary note 11, further including:
a numerical value decision unit that decides a plurality of numerical values associated with each of the plurality of small regions;
an iris pattern creation unit that creates the iris pattern in which the plurality of small regions have brightness according to each associated numerical value;
a black eye creation unit that creates a black eye image formed of a pupil region with a circular shape being associated with a pupil, and the iris region being circumscribed on the pupil region and provided with the iris pattern; and
a chart creation unit that creates a chart image including one or a plurality of the black eye images.
   13. The information processing apparatus according to supplementary note 12, wherein
the iris pattern creation unit includes
   a first creation unit that creates a rectangular pattern in which each of a plurality of small rectangular regions acquired by dividing a rectangular region has brightness according to the plurality of numerical values, and
   a second creation unit that creates the iris pattern by deforming the rectangular pattern into a band annular shape.
      14. The information processing apparatus according to supplementary note 13, wherein the second creation unit creates the iris pattern by performing a computation for converting a polar coordinate system into an orthogonal coordinate system on the rectangular pattern.
      15. The information processing apparatus according to any one of supplementary notes 12 to 14,wherein
the chart image is a specific test chart image including a plurality of specific iris patterns that are iris patterns for evaluating a resolution in the imaging setting,
each of the plurality of specific iris patterns is a pattern in which brightness is different from each other in at least a part of a plurality of small regions acquired by dividing an iris region with a band annular shape being associated with an iris,
the resolution is associated with a number of the small regions configuring each of the plurality of specific iris patterns, and
the plurality of specific iris patterns have resolutions different from each other.
   16. The information processing apparatus according to supplementary note 15, wherein the numerical value decision unit decides a plurality of numerical values associated with each of the plurality of small regions configuring each of the plurality of specific iris patterns, based on an iris image in which an iris of a person is imaged,
the iris pattern creation unit creates the plurality of specific iris patterns in which the plurality of small regions have brightness according to each associated numerical value,
the black eye creation unit creates, for each of the plurality of specific iris patterns, a specific black eye image formed of a pupil region with a circular shape being associated with a pupil, and the iris region being circumscribed on the pupil region and provided with the specific iris pattern, and
the chart creation unit creates a specific test chart image including a plurality of the specific black eye images.
   17. The information processing apparatus according to supplementary note 16, wherein
brightness of each of the plurality of small regions is indicated by two gray levels,
the numerical value decision unit decides a numerical value associated with the small region, based on a pixel value of a portion of the iris image associated with each of the plurality of small regions configuring each of the plurality of specific iris patterns, and
the decided numerical value is associated with a gray level of the brightness.
   18. An information processing method including,
by one or more computers,
creating a chart image including an iris pattern for evaluating at least one of an imaging environment and an imaging setting.
   19. A medium that stores a program for causing one or more computers to execute
creating a chart image including an iris pattern for evaluating at least one of an imaging environment and an imaging setting.
   20. An information processing apparatus including:
a chart image acquisition unit that acquires a chart image including an iris pattern for evaluating at least one of an imaging environment and an imaging setting; and
a display control unit that causes a display unit to display the chart image.
   21. An information processing method including,
by one or more computers:
acquiring a chart image including an iris pattern for evaluating at least one of an imaging environment and an imaging setting; and
causing a display unit to display the chart image.
   22. A medium that stores a program for causing one or more computers to execute:
acquiring a chart image including an iris pattern for evaluating at least one of an imaging environment and an imaging setting; and
causing a display unit to display the chart image.
   23. An information processing apparatus including:
an imaging image acquisition unit that acquires a chart imaging image being an image in which an imaging test chart or a chart image including an iris pattern for evaluating at least one of an imaging environment and an imaging setting is imaged;
a registration data acquisition unit that acquires registration data including an iris pattern included in the imaging test chart or the chart image;
a detection unit that detects an iris pattern from the acquired chart imaging image;
a verification unit that verifies the detected iris pattern with an iris pattern included in the registration data;
a score acquisition unit that obtains an evaluation score for evaluating at least one of the iris pattern and the chart imaging image, based on a result of at least one of the detection and the verification; and
an output control unit that causes an output unit to output a value based on the evaluation score.
   24. The information processing apparatus according to supplementary note 23, wherein
the evaluation score includes at least one of a degree of similarity for each of the iris patterns included in the chart imaging image, a degree of reliability indicating a degree that the degree of similarity can be relied on, a detection time required for detecting an iris pattern from the chart imaging image, a total value and an average value of the degrees of similarity for a whole of iris patterns included in the chart imaging image, a total value and an average value of the degrees of reliability, and a total value and an average value of the detection times.
   25. The information processing apparatus according to supplementary note 23 or 24, wherein
the output unit includes a display unit that displays the evaluation score, and
the output control unit includes a display control unit that causes the display unit to display the evaluation score in association with at least one of the iris pattern and the chart imaging image that are related to the evaluation score.
   26. The information processing apparatus according to supplementary note 25, wherein the imaging test chart or the chart image includes a plurality of black eye images that are provided in positions different from each other and including iris patterns different from each other.
   27. The information processing apparatus according to supplementary note 26, wherein
the registration data include a plurality of iris patterns included in the imaging test chart or the chart image, and
the display control unit includes
   a position determination unit that determines a position, in the chart imaging image of an associated iris pattern, of each of iris patterns included in the registration data, based on a result of verification, and
   an association unit that causes a display unit to display the evaluation score related to the registered iris pattern in association with the iris pattern IRP or a chart imaging image including the iris pattern IRP, based on the determined position.
      28. The information processing apparatus according to any one of supplementary notes 23 to 27, further including
an adjustment control unit that performs processing for adjusting the imaging environment, based on the evaluation score.
   29. The information processing apparatus according to any one of supplementary notes 23 to 28, wherein
the imaging test chart or the chart image is a specific test chart or a specific test chart image including a plurality of specific iris patterns that are iris patterns for evaluating a resolution in the imaging setting,
the chart imaging image is a specific test chart imaging image in which the specific test chart or the chart image is imaged,
the registration data include a plurality of specific iris patterns included in the specific test chart or the chart image,
the evaluation score includes a resolution evaluation score for evaluating each of the plurality of specific iris patterns,
the imaging image acquisition unit acquires the specific test chart imaging image,
the detection unit detects a plurality of specific iris patterns from the acquired specific test chart imaging image,
the verification unit verifies the plurality of detected specific iris patterns with a plurality of specific iris patterns included in the registration data,
the score acquisition unit obtains the resolution evaluation score of each of the plurality of specific iris patterns, based on a result of at least one of the detection and the verification, and
the output control unit causes the output unit to output a resolution determined based on the resolution evaluation score.
   30. The information processing apparatus according to supplementary note 29, wherein
the output unit includes a transmission unit that performs transmission to an apparatus that creates a specific test chart image, and
the output control unit includes
   a resolution determination unit that determines a resolution of the specific iris pattern associated with maximum of the resolution evaluation score among a plurality of the evaluation resolution scores obtained for the plurality of specific iris patterns, and
   a transmission control unit that causes the transmission unit to transmit the determined resolution.
      31. The information processing apparatus according to supplementary note 29 or 30, wherein
the resolution evaluation score is at least one of an index indicating a possibility of other person acceptance by verification, and a degree of similarity between the detected specific iris pattern and a specific iris pattern included in the registration data.
   32. An information processing method including,
by one or more computers:
acquiring a chart imaging image being an image in which an imaging test chart or a chart image including an iris pattern for evaluating at least one of an imaging environment and an imaging setting is imaged;
acquiring registration data including an iris pattern included in the imaging test chart or a chart image;
detecting an iris pattern from the acquired chart imaging image;
verifying the detected iris pattern with an iris pattern included in the registration data;
obtaining an evaluation score for evaluating at least one of the iris pattern and the chart image, based on a result of at least one of the detection and the verification; and
causing an output unit to output the evaluation score.
   33. A medium that stores a program for causing one or more computer to execute:
acquiring a chart imaging image being an image in which an imaging test chart or a chart image including an iris pattern for evaluating at least one of an imaging environment and an imaging setting is imaged;
acquiring registration data including an iris pattern included in the imaging test chart or the chart image;
detecting an iris pattern from the acquired chart imaging image;
verifying the detected iris pattern with an iris pattern included in the registration data;
obtaining an evaluation score for evaluating at least one of the iris pattern and the chart image, based on a result of at least one of the detection and the verification; and
causing an output unit to output the evaluation score.

### REFERENCE SIGNS LIST

100 Imaging test chart (test chart)
102 Black eye image
102a Specific black eye image
103 Pupil region
104 Iris region
105_j, 105_1 to 105_48 Small region
110, 210 Information processing system
M1 Chart creation apparatus (information processing apparatus)
M2, M6 Evaluation apparatus (information processing apparatus)
CM Imaging apparatus
112 Numerical value decision unit
113 Iris pattern creation unit
114 Black eye creation unit
115 Chart creation unit
116 Chart output unit
117 Chart storage unit
118 First creation unit
119 Second creation unit
121 Imaging image acquisition unit
122 Registration data storage unit
123 Registration data acquisition unit
124 Detection unit
125 Verification unit
126 Score acquisition unit
127 Output unit
128 Output control unit
130 Display unit
131 Transmission unit
132 Display control unit
133 Transmission control unit
134 Position determination unit
135 Association unit
214 Chart display apparatus (information processing apparatus)
241 Chart image acquisition unit
242 Display unit
243 Display control unit
351 Resolution determination unit
661 Adjustment control unit
662 Environment adjustment unit

What is claimed is:

1. An imaging test chart comprising
an iris pattern for evaluating at least one imaging condition.

2. The imaging test chart according to claim 1, wherein
the iris pattern includes a plurality of regions.
a brightness of a first region of the iris pattern and a brightness of a second region of the iris pattern are different.

3. The imaging test chart according to claim 2, further comprising
a pupil region with a circular shape
the iris pattern circumscribes the pupil region, and
the plurality of regions are concentric with the pupil region.

4. The imaging test chart according to claim 3, wherein
the pupil region and the iris pattern form a first eye image, and
the imaging test chart further comprises a second eye image including a second pupil region and a second iris pattern, wherein
the first eye image and the second eye image are located at different positions.

5. The imaging test chart according to claim 4, wherein
the first eye image and the second first eye image include different iris patterns.

6. The imaging test chart according to claim 5, wherein
the iris patterns have different resolutions other, and
the resolutions of the iris patterns correspond to a number of the regions.

7. The imaging test chart according to claim 2, wherein
an outer diameter of the iris region correspond to an outer diameter of an actual iris.

8. The imaging test chart according to claim 2, wherein
an outer diameter of the iris region is from 10 millimeters to 12 millimeters.

9. (Canceled)

10. An information processing apparatus comprising
at least one memory storing instructions configured to cause a processor to:
output a signal representing a chart image including an iris pattern for evaluating at least one imaging condition.

11. The information processing apparatus according to claim 10, wherein
the iris pattern includes a plurality of regions,
a brightness of a first region of the iris pattern and a brightness of a second region of the iris pattern are different.

12. The information processing apparatus according to claim 11, wherein the instructions are further configured to cause a processor to
determine values associated with the plurality of small regions;
create the iris pattern in which the plurality of small regions have brightnesses based on the values.
create an eye image including a pupil region and the iris region circumscribing the pupil region; and
output a signal to representing the chart image including at least the eye image.

13. The information processing apparatus according to claim 12, wherein the instructions are further configured to cause a processor to:
create a pattern of rectangular regions having brightnesses based on the values, and
create the iris pattern by transforming the rectangular pattern into an annular shape.

14. The information processing apparatus according to claim 13, wherein
the annular shape is created by converting a polar coordinate system into an orthogonal coordinate system of the rectangular pattern.

15. The information processing apparatus according to claim 12, wherein
the chart image includes a plurality of iris patterns for evaluating at least one imaging condition,
the iris pattern includes a plurality of regions,
a brightness of a first region of the iris pattern and a brightness of a second region of the iris pattern are different,
a pupil region with a circular shape,
the iris pattern circumscribes the pupil region,
the plurality of regions are concentric with the pupil region,
the pupil region and the iris pattern form a first eye image, and
the imaging test chart further comprises a second eye image including a second pupil region and a second iris pattern, wherein
the first eye image and the second eye image are located at different positions and include different iris patterns,
the iris patterns have different resolutions, and
the resolutions of the iris patterns correspond to a number of the regions.

16. The information processing apparatus according to claim 15, wherein
the chart image comprises:
the eye image, and
a second eye image that includes a second pupil region and a second iris pattern, and
wherein the first eye image and the second eye image are located at different positions.

17. The information processing apparatus according to claim 16, wherein
brightness of each of the plurality of small regions is indicated by a gradation level, and
the value corresponds to the gradation level of the brightness.

18. An information processing method comprising,
by one or more computers,
output a signal representing a chart image including an iris pattern for evaluating at least one imaging condition.

19-33. (canceled)

34. The imaging test chart according to claim 2, wherein
the plurality of regions have annular shapes.

35. The imaging test chart according to claim 2, wherein
the plurality of regions have wedge shapes.

36. The imaging test chart according to claim 1, wherein
the imaging test chart is stored on a computer readable medium.
